(19) United States
(12) Patent Application Publication
(10) Pub. No.: US 2023/0133105 A1
(43) Pub. Date: May 4, 2023

(54) CROSS-MAILLARDIZED PLANT SUBSTRATES

(71) Applicant: Atomo Coffee, Inc., Seattle, WA (US)

(72) Inventors: Jarret Stopforth, Seattle, WA (US); Charles M. Shaw, Seattle, WA (US)

(21) Appl. No.: 17/915,468

(22) PCT Filed: Apr. 2, 2021
(86) PCT No.: PCT/US2021/025565

§ 371 Date: Sep. 28, 2022

Related U.S. Application Data
(60) Provisional application No. 63/005,158, filed on Apr. 3, 2020.

(51) Int. Cl. A23F 5/44; A23F 5/46; A23L 2/56

(52) U.S. Cl. CPC A23F 5/44; A23F 5/46; A23L 2/56

(57) ABSTRACT

Provided are modified coffee and/or coffee-substitute composition, and the methods of making same, comprising cross-Maillardized substrate carrier materials or non-cross-Maillardized carrier material, having cross-Maillardized reaction products providing for improved coffee and/or coffee or more organoleptically accurate coffee substitute compositions than presently exist.

### FIELD OF THE INVENTION

The invention disclosed herein generally relates to coffee-substitute components and products made with, but preferably without coffee beans, more particularly to methods for making cross-Maillardized coffee and coffee-substitute substrate materials and products thereof, and even more particularly to cross-Maillardized coffee and coffee-substitute materials including but not limited to extractable coffee and coffee-substitutes and extracts thereof, and including kernels, grounds, beverages, concentrates, flavorings, etc., based thereon, all which are preferably made without coffee beans.

### BACKGROUND

Alleged coffee substitutes, derived from raw materials other than coffee beans/cherries, have historically been pursued for numerous reasons including, for example, coffee bean shortages or limited availability, excessive cost, and caffeine avoidance. Exemplary substitute ingredients include chicory (e.g., in Europe), acorns (e.g., North America), yerba mate (e.g., South America), date seeds (e.g., Middle East), etc. A given substitute will typically have at least some structural and/or compositional similarities to coffee beans, and thus will frequently be treated and processed as if it was coffee bean material in an attempt to produce a coffee-like beverage from it. For example, a coffee substitute raw material may be harvested, cleaned, roasted, ground and extracted as if it were coffee beans, but since none of these ingredients has the same structure and/or composition as green coffee beans, they do not produce, upon such processing, beverages that accurately replicate the organoleptic properties of coffee; that is, traditional coffee substitutes, despite being subjected to traditional coffee bean processing steps and conditions, do not recapitulate or sufficiently approach the coffee experience, and the results are at best an alternative, not an organoleptic substitute to the familiar coffee experience.

While research in recent years has been directed at identifying key components of green and/or roasted coffee that contribute to its distinctive aroma, taste, texture and color, alternative raw materials may (and typically do) either lack particular key coffee components, contain excessive amounts of particular coffee components, and/or contain different components that may generate undesirable properties upon application of traditional coffee processing steps. For the same reasons, traditional flavor ingredients, alone or in combination with such alternative raw materials (e.g., augmented raw materials) do not sufficiently recapitulate or approach the coffee experience.

Additionally, certain compounds found in coffee seeds and coffee beverages may be problematic for organoleptic qualities or for human health. For example, the amino acid asparagine is known to produce the undesirable toxin acrylamide during the coffee roasting process.

There is, therefore, a pronounced need for methods that functionally (e.g., chemically and organoleptically) integrate exogenous ingredients/reactants with endogenous reactive components of traditional coffee, or of alternative non-coffee raw materials to provide improved coffee and more organoleptically accurate coffee-substitutes, and which also allow for coffee and coffee-substitute formulations in which desired or undesired compounds may be omitted, removed, degraded, diminished, altered, modulated or increased prior to or during processing.

### SUMMARY OF EXEMPLARY EMBODIMENTS OF THE INVENTION

Embodiments of the disclosure can be described in view of the following clauses:

1. A method of preparing a beverage component, comprising: contacting a substrate carrier material, having an endogenous Maillard-reactive nitrogen constituent and/or an endogenous Maillard-reactive carbohydrate constituent, with an exogenous Maillard reagent comprising an exogenous Maillard-reactive nitrogen constituent and/or an exogenous Maillard-reactive carbohydrate constituent to provide a conditioned substrate carrier material; and adjusting the water activity (a_{w}) of the conditioned substrate carrier material to a value less than that of the conditioning reaction, and reacting, during the adjusting and/or at the adjusted aw value, the exogenous Maillard reagent with the endogenous Maillard-reactive nitrogen constituent and/or with the endogenous Maillard-reactive carbohydrate constituent to provide a low water activity (low aw) cross-Maillardized substrate carrier material having cross-Maillard reaction products (LWACMP) formed by the reaction between the exogenous Maillard reagent, and the endogenous Maillard-reactive constituent(s).

2. The method of clause 1 wherein the conditioned substrate carrier material, prior to adjusting the aw, comprises a cross-Maillardized substrate carrier material having cross-Maillard reaction products (HWACMP).

3. The method of clause 1 or 2, wherein the endogenous Maillard-reactive nitrogen constituent comprises one or more of amino acids, oligopeptides, polypeptides, and/or proteins, and/or wherein the endogenous Maillard-reactive carbohydrate constituent comprises one or more of mono-, di-, oligosaccharide, and/or polysaccharides.

4. The method of any one of clauses 1-3, wherein the exogenous Maillard-reactive nitrogen constituent comprises one or more of amino acids, oligopeptides, polypeptides, and/or proteins, and/or wherein the exogenous Maillard-reactive carbohydrate constituent comprises one or more of mono-, di-, oligosaccharide, and/or polysaccharides.

5. The method of any one of clauses 1-4, wherein the exogenous Maillard-reactive nitrogen constituent comprises one or more amino acids, and/or wherein the exogenous Maillard-reactive carbohydrate constituent comprises one or more mono- or disaccharides.

6. The method of any one of clauses 1-5, wherein the substrate carrier material comprises a natural and/or a processed or restructured plant material having the endogenous Maillard-reactive nitrogen constituent and/or the endogenous Maillard-reactive carbohydrate constituent.

7. The method of clause 6, wherein the plant material comprises one or more selected from the group consisting of date seeds, chicory root, Yerba mate stems and/or leaves, dandelion, seeds from the mustard family (Brassicaceae), watermelon seeds, pumpkin seeds, Jerusalem artichokes, sesame seeds, cereal and non-cereal grains, and/or coffee.

8. The method of any one of clauses 1-7, wherein contacting the substrate carrier material with the exogenous Maillard reagents comprises contacting with an aqueous solution of the exogenous Maillard reagents.

9. The method of any one of clauses 1-8, wherein contacting the substrate carrier material with the exogenous Maillard reagent comprises contacting at least the surface of the substrate carrier material with the exogenous Maillard reagent, and promoting adsorption, absorption, or adherence (e.g., covalently or physically) of the exogenous Maillard reagent, and/or of reaction products thereof, to at least the surface of the conditioned carrier material.

10. The method of any one of clauses 1-9, wherein contacting the substrate carrier material with the exogenous Maillard reagent comprises contacting at one or more conditioning temperature(s), under conditions and for a time period sufficient to provide for infusion of the exogenous Maillard reagent into at least the surface of the substrate carrier material, and/or solubilization and/or depolymerization of the endogenous Maillard-reactive nitrogen constituent and/or the endogenous Maillard-reactive carbohydrate constituent thereof.

11. The method of any one of clauses 1-10, wherein the LWACMP comprises cross-Maillardized reaction products on at least the surface thereof.

12. The method of any one of clauses 1-11, wherein adjusting the aw comprises adjusting to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.1, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70.

13. The method of any one of clauses 1-12, wherein adjusting the aw comprises drying the conditioned substrate carrier material at one or more drying temperatures.

14. The method of any one of clauses 1-13, further comprising restructuring one or more of the substrate carrier material, the conditioned substrate carrier material, and/or the LWACMP.

15. The method of any one of clauses 1-14, wherein the restructuring comprises one or more of fragmenting, grinding, milling, micronizing, depolymerizing, solubilizing, permeabilizing, compacting and/or compressing the respective substrate carrier material.

16. The method of any one of clauses 1-15, further comprising heating the LWACMP under conditions sufficient to promote further Maillardization thereof, to provide an elevated temperature, cross-Maillardized substrate carrier material having cross-Maillard reaction products (ET-LWACMP).

17. The method of clause 16, wherein the adjusting the water activity (aw) of the conditioned substrate carrier material to provide the LWACMP, and the heating of the LWACMP to provide the ET-LWACMP are stages of one or more continuous or ramped heating process(es).

18. The method of clause 16 or 17, wherein the further Maillardization comprises further cross-Maillardization relative to the LWACMP.

19. The method of any one of clauses 16-18, wherein the heating is at one or more temperatures greater than the temperature used for adjusting the water activity (aw) of the conditioned substrate carrier material, or than the drying temperature.

20. The method of any one of clauses 16-19, wherein the heating comprises one or more of roasting, toasting, baking, grilling, and/or otherwise thermally treating at elevated temperatures.

21. The method of any one of clauses 16-20, further comprising grinding, or otherwise fragmenting, grinding, milling, micronizing, depolymerizing, solubilizing, permeabilizing, compacting, compressing and/or otherwise restructuring the ET-LWACMP.

22. The method of any one of clauses 1-21, wherein the level of at least one compound present in the conditioned substrate carrier material, the LWACMP, the ET-LWACMP, or in extracts thereof is differentially modulated relative to that of the substrate carrier material or that of the exogenous reagent(s) independently subjected to the method, taken alone or in sum.

23. The method of clause 22, wherein the at least one compound comprises 2,5-dimethylpyrazine, 2,3-butanedione, 1,3-bis[(5S)-5-amino-5-carboxypentyl]-4-methyl-1H-imidazol-3-ium and/or of γ-butyrolactone.

24. The method of any one of clauses 1-23, further comprising extracting the conditioned substrate carrier material, the LWACMP or the ET-LWACMP to provide an extract, and an extracted retentate substrate carrier material.

25. The method of clause 24, wherein the extracting comprises suffusing or steeping in a suitable solvent (e.g., water, ethanol, glycol, supercritical CO₂, etc.) at a suitable temperature, wherein the extract comprises an infusion, and wherein the extracted retentate substrate carrier material comprises extracted retentate restructured substrate and/or grounds.

26. The method of clause 24 or 25, further comprising addition of one or more additional ingredients to the extract to provide a blended formula.

27. The method of clause 26, wherein the one or more additional ingredients comprises one or more of dry ingredients, liquid ingredients, oil, and/or gum ingredients.

28. The method of any one of clauses 24-27, comprising concentrating the extract or the blended formula, to provide a concentrated extract or concentrated blended formula.

29. The method of any one of clauses 24-28, further comprising subjecting the extract or the blended formula, or the concentrates thereof, to one or more of a sterilization process (e.g. UHT, retort, microwave, ohmic), a pasteurization process (e.g. HTST), a homogenization process, or non-thermal antimicrobial treatments (e.g. HPP, irradiation) etc., optionally followed by packaging or aseptic packaging.

30. The method of any one of clauses 24-29, further comprising drying of the extracted retentate substrate carrier material to provide a dried, extracted retentate substrate carrier material.

31. The method of clause 30, further comprising addition of one or more additional ingredients to the dried, extracted retentate substrate carrier material to provide a formulated retentate substrate carrier material.

32. The method of clause 31, wherein the addition of the one or more additional ingredients, comprises coating or infusing the dried, extracted retentate substrate carrier material.

33. The method of clause 31 or 32, wherein the one or more additional ingredients comprises one or more of dry ingredients, liquid ingredients, oil, gum ingredients, and/or an extract or lyophilized or dried extract of the LWACMP or of the ET-LWACMP.

34. The method of any one of clauses 24-33, further comprising instantizing the extract, the blended formula, or the concentrates thereof, to provide an instantized beverage component, optionally followed by aseptic packaging.

35. The method of any one of clauses 1-34, wherein the substrate carrier material comprises or is coffee or spent coffee grounds.

36. A beverage component, comprising a component prepared by the method of any one of clauses 1-35.

37. The beverage component of clause 36, wherein the beverage component comprises one or more of: a conditioned substrate carrier material having cross-Maillard reaction products (HWACMP); a low aw cross-Maillardized substrate carrier material (LWACMP) having cross-Maillard reaction products; an elevated temperature, cross-Maillardized substrate carrier material (ET-LWACMP) having cross-Maillard reaction products formed by heating the LWACMP under conditions sufficient to promote further Maillardization thereof; an extract of the HWACMP, the LWACMP, or the ET-LWACMP, or concentrates, blends or formulations thereof; an extracted retentate substrate carrier material having cross-Maillard reaction products; and a concentrated and/or instantized beverage component; and wherein any of these components are optionally packaged in single-use or multi-use pods, capsule, etc.

38. A cross-Maillardized substrate carrier material, or an extract thereof, comprising: a low water activity (low aw) cross-Maillard reaction product (LWACMP) formed, at an aw value less than or equal to 0.95, between an endogenous Maillard-reactive nitrogen constituent and an exogenous Maillard-reactive carbohydrate constituent, and/or between an exogenous Maillard-reactive nitrogen constituent and an endogenous Maillard-reactive carbohydrate constituent; and/or an elevated temperature, low water activity cross-Maillard product (ET-LWACMP).

39. The cross-Maillardized substrate carrier material, or the extract thereof, of clause 38, comprising LWACMP and ET-LWACMP.

40. The cross-Maillardized substrate carrier material, or the extract thereof, of clause 38 or 39, wherein the endogenous Maillard-reactive nitrogen constituent comprises one or more of amino acids, oligopeptides, polypeptides, and/or proteins, and/or wherein the endogenous Maillard-reactive carbohydrate constituent comprises one or more of mono-, di-, oligosaccharide, and/or polysaccharides.

41. The cross-Maillardized substrate carrier material, or the extract thereof, of any one of clauses 38-40, wherein the exogenous Maillard-reactive nitrogen constituent comprises one or more of amino acids, oligopeptides, polypeptides, and/or proteins, and/or wherein the exogenous Maillard-reactive carbohydrate constituent comprises one or more of mono-, di-, oligosaccharide, and/or polysaccharides.

42. The cross-Maillardized substrate carrier material, or the extract thereof, of any one of clauses 38-41, wherein the exogenous Maillard-reactive nitrogen constituent comprises one or more amino acids, and/or wherein the exogenous Maillard-reactive carbohydrate constituent comprises one or more mono- or disaccharides.

43. The cross-Maillardized substrate carrier material, or the extract thereof, of any one of clauses 38-42, wherein the substrate carrier material comprises a natural and/or a processed or restructured plant material.

44. The cross-Maillardized substrate carrier material, or the extract thereof, of clause 43 wherein the plant material comprises one or more selected from the group consisting of date seeds, chicory root, Yerba mate stems and/or leaves, dandelion, seeds from the mustard family (Brassicaceae), watermelon seeds, pumpkin seeds, Jerusalem artichokes, sesame seeds, cereal and non-cereal grains and/or coffee.

45. The cross-Maillardized substrate carrier material, or the extract thereof, of clause 44 wherein the plant material comprises or is coffee or spent coffee grounds.

46. The cross-Maillardized substrate carrier material, or the extract thereof, of any one of clauses 38-45, wherein the cross-Maillardized substrate carrier material comprises one or more of: a kernel or restructured form of the cross-Maillardized substrate carrier material having LWACMP, of the cross-Maillardized substrate carrier material having ET-LWACMP, or of the cross-Maillardized substrate carrier material having LWACMP and ET-LWACMP; an extract (e.g., aqueous) of the kernel or fragmented form of the cross-Maillardized substrate carrier material having LWACMP, of the cross-Maillardized substrate carrier material having ET-LWACMP, or of the cross-Maillardized substrate carrier material having LWACMP and ET-LWACMP; a concentrated and/or instantized extract of the kernel or fragmented form of the cross-Maillardized substrate carrier material having LWACMP, of the cross-Maillardized substrate carrier material having ET-LWACMP, or of the cross-Maillardized substrate carrier material having LWACMP and ET-LWACMP; and an extracted retentate cross-Maillardized substrate carrier material having LWACMP, having ET-LWACMP, or having LWACMP and ET-LWACMP; and wherein any of these components are optionally packaged in single-use or multi-use pods, capsule, etc.

47. The cross-Maillardized substrate carrier material, or the extract thereof, of any one of clauses 38-46, in the form of a beverage or beverage component.

48. The cross-Maillardized substrate carrier material, or the extract thereof, of any one of clauses 38-47, wherein the level of at least one compound present in the LWACMP, in the ET-LWACMP, or in extracts thereof is differentially modulated relative to that of a corresponding non-cross-Maillardized substrate carrier material.

49. The cross-Maillardized substrate carrier material, or the extract thereof, of clause 48 wherein the at least one compound comprises 2,5-dimethylpyrazine, 2,3-butanedione, 1,3-bis[(5S)-5-amino-5-carboxypentyl]-4-methyl-1H-imidazol-3-ium and/or of γ-butyrolactone.

50. A cross-Maillard-primed substrate carrier material, comprising a non-liquid combination of: a substrate carrier material having an endogenous Maillard-reactive nitrogen constituent and/or an endogenous Maillard-reactive carbohydrate constituent; and an exogenous Maillard reagent having an exogenous Maillard-reactive nitrogen constituent and/or an exogenous Maillard-reactive carbohydrate constituent, wherein the non-liquid combination is primed (sufficient or capable) to produce a cross-Maillardized substrate carrier material upon adjustment of water activity (a_{w}), and/or heating, and/or drying thereof; optionally packaged in single-use or multi-use pods, capsule, etc.

51. The cross-Maillard-primed substrate carrier material of clause 50, wherein: the endogenous Maillard-reactive nitrogen constituent comprises one or more of amino acids, oligopeptides, polypeptides, and/or proteins; and/or wherein the endogenous Maillard-reactive carbohydrate constituent comprises one or more of mono-, di-, oligosaccharide, and/or polysaccharides; and/or wherein the exogenous Maillard-reactive nitrogen constituent comprises one or more of amino acids, oligopeptides, polypeptides, and/or proteins; and/or wherein the exogenous Maillard-reactive carbohydrate constituent comprises one or more of mono-, di-, oligosaccharide, and/or polysaccharides.

52. The cross-Maillard-primed substrate carrier material of clause 50 or 51, wherein adjusting the a_{w} comprises adjusting to a value greater than 0.95, or to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.10, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70; wherein drying comprises adjusting the a_{w} to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.10, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70; and wherein heating comprises heating at, or to, a temperature above ambient temperature.

53. The cross-Maillard-primed substrate carrier material of any one of clauses 50-52, wherein the non-liquid combination comprises a powder or particle form of either the substrate carrier material, the exogenous Maillard reagent, or both.

54. The cross-Maillard-primed substrate carrier material of any one of clauses 50-53, wherein the substrate carrier material and/or the exogenous Maillard reagent are in the form of a bound or unbound aggregate, a direct compression, a dry granulation, wet granulation, extrusion and in each case may optionally comprise one or more further excipients (e.g., binder, distintegrant, lubricant, etc.).

55. The cross-Maillard-primed substrate carrier material of any one of clauses 50-54, wherein the substrate carrier material and the exogenous Maillard reagent are in the form of a compressed or compacted, bound or unbound, kernel, bean, pellet or other form.

56. The cross-Maillard-primed substrate carrier material of any one of clauses 50-55, wherein the substrate carrier material comprises a natural and/or a processed or restructured plant material.

57. The cross-Maillard-primed substrate carrier material of clause 56, wherein the plant material comprises one or more selected from the group consisting of date seeds, chicory root, Yerba mate stems and/or leaves, dandelion, seeds from the mustard family (Brassicaceae), watermelon seeds, pumpkin seeds, Jerusalem artichokes, sesame seeds, cereal and non-cereal grains and/or coffee.

58. The cross-Maillard-primed substrate carrier material of clause 57, wherein the plant material comprises or is coffee or spent coffee grounds.

59. A method of making a cross-Maillard-primed substrate carrier material, comprising combining: a substrate carrier material having an endogenous Maillard-reactive nitrogen constituent and/or an endogenous Maillard-reactive carbohydrate constituent; and an exogenous Maillard reagent having an exogenous Maillard-reactive nitrogen constituent and/or and exogenous Maillard-reactive carbohydrate constituent, to provide a non-liquid combination, wherein the non-liquid combination is primed (sufficient or capable) to produce a cross-Maillardized substrate carrier material upon adjustment of water activity (a_{w}), and/or heating, and/or drying thereof.

60. The method of clause 59, wherein: the endogenous Maillard-reactive nitrogen constituent comprises one or more of amino acids, oligopeptides, polypeptides, and/or proteins; and/or wherein the endogenous Maillard-reactive carbohydrate constituent comprises one or more of mono-, di-, oligosaccharide, and/or polysaccharides; and/or wherein the exogenous Maillard-reactive nitrogen constituent comprises one or more of amino acids, oligopeptides, polypeptides, and/or proteins; and/or wherein the exogenous Maillard-reactive carbohydrate constituent comprises one or more of mono-, di-, oligosaccharide, and/or polysaccharides.

61. The method of clause 59 or 60, wherein: adjusting the a_{w} comprises adjusting to a value greater than 0.95, or to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.10, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70; wherein drying comprises adjusting the a_{w} to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.10, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70; and wherein heating comprises heating at, or to, a temperature above ambient temperature.

62. The method of any one of clauses 59-61 wherein the non-liquid combination comprises a powder or particle form of either the substrate carrier material, the exogenous Maillard reagent, or both.

63. The method of any one of clauses 59-62, wherein the substrate carrier material and/or the exogenous Maillard reagent are in the form of a bound or unbound aggregate, a direct compression, a dry granulation, wet granulation, or extrusion, and in each case may optionally comprise one or more further excipients (e.g., binder, disintegrant, lubricant, etc.).

64. The method of any one of clauses 59-63, wherein the substrate carrier material and the exogenous Maillard reagent are in the form of a compressed or compacted, bound or unbound, kernel, bean, pellet or other form.

65. The method of any one of clauses 59-64, wherein the substrate carrier material comprises or is a natural and/or a processed or restructured plant material.

66. The method of any one of clauses 59-65, wherein the plant material comprises or is one or more selected from the group consisting of date seeds, chicory root, Yerba mate stems and/or leaves, dandelion, seeds from the Brassicaceae family, watermelon seeds, pumpkin seeds, Jerusalem artichokes, sesame seeds, cereal and non-cereal grains and/or coffee.

67. The method of clause 66, wherein t the plant material comprises or is coffee or spent coffee grounds.

68. A cross-Maillard-primed substrate carrier material, prepared the method of any one of clauses 59-67.

69. A method for imparting flavor and/or aroma to a cross-Maillardized or non-cross-Maillardized carrier material comprising: obtaining a substrate carrier material; and applying a beverage component according to clause 36 or 37, and/or applying a cross-Maillardized substrate carrier material, or an extract thereof, according to any one of clauses 38-49.

70. The method of clause 69, wherein the carrier material comprises or is a natural and/or a processed or restructured plant material.

71. The method of clause 70, wherein the plant material comprises one or more materials selected from the group consisting of date seeds, chicory root, Yerba mate stems and/or leaves, dandelion, seeds from the Brassicaceae family, watermelon seeds, pumpkin seeds, Jerusalem artichokes, sesame seeds, cereal and non-cereal grains and/or coffee.

72. The method of clause 71, wherein the plant material comprises or is coffee or spent coffee grounds.

73. A flavor and/or aroma enhanced carrier material prepared by the method of any one of clauses 69-72.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 schematically shows, by way of non-limiting examples of the present invention, a high-level depiction of a first embodiment of a method for production of coffee-substitute beverage products.

FIG. 2 depicts the levels of 2,5-DMP generated in various steps, and particularly the low levels of 2,5-DMP generated in the preconditioning and drying steps, for Control, CrossMR, and MR samples. Cross reactions between the exogenous reagents and the substrate are observed, as evidenced by the elevated levels of 2,5-DMP generated when substrate and reagents are reacted together.

FIG. 3 depicts results from experiments conducted across exemplary example compositions, showing that careful selection of substrate and reagent is key to produce the desired final products and that addition of some Maillard reagents can result in decreased yield of desired compounds.

FIG. 4 depicts the production of 2,3-butanedione in the various example compositions, showing that flavorful aroma compounds resulting from the interaction of exogenous and substrate materials are also generated in greater yield using these inventive compositions.

FIG. 5 depicts scanning electron microscopy results showing changes in the cellular structure based on the cross-Maillard reactivity; the Control (left) samples show a highly porous structure, whereas CrossMR (right) samples exhibit a more dense and fuller cellular structure.

FIG. 6 depicts LC/MS results from semi-quantitation of 1,3-bis[(5S)-5-amino-5-carboxypentyl]-4-methyl-1H-imidazol-3-ium in the Control, Cross-MR and MR sample, showing that this compound is exclusively formed in the Cross-MR approach.

FIG. 7 shows, according to additional aspects of the invention, modulation of particular coffee aroma compounds in a cross-Maillardized raw (“green”) coffee beans composition

FIG. 8 shows, according to additional aspects of the invention, generation of particular roast aroma compounds by cross-Maillardization of previously roasted, ground and extracted coffee beans.

FIG. 9 shows, according to additional aspects of the invention, that initial cracking of the date seeds prior to preconditioning enhances the yield of cross-Mailladization products.

FIGS. 10A and 10B show, according to additional aspects of the invention, that addition of chlorogenic acid to the preconditioning reaction modulates (in this instance decreases) the level of 2,5-dimethylpyrazine generated (FIG. 10A), and that while cross-Maillaridization lowers the level of γ-butyrolactone relative to non-cross-Maillardized cracked date seeds (control cracked date seeds), addition of chlorogenic acid to the cross-Maillardization preconditioning mixture enhances the yield of γ-butyrolactone in cross-Maillardized date seeds.

FIG. 11 shows, according to additional aspects of the invention, that fermenting the date seeds prior to preconditioning enhances the yield of cross-Maillardization products.

### DETAILED DESCRIPTION OF THE INVENTION

Unless otherwise noted (see “DEFINITIONS” below), terms are to be understood according to conventional usage by those of ordinary skill in the relevant art.

The present invention includes fundamentally different methods for producing desirable coffee and/or coffee-substitute compositions by integrating exogenous reactants (e.g., exogenous reagents comprising particular reactants) into coffee or non-coffee substrate carrier materials (e.g., raw/natural, crude or processed agricultural (e.g., plant-based) products). The functional/organoleptic coffee and/or coffee-like components are created through cross-reactive processes (e.g., Maillard reactions) occurring between the exogenously introduced reagents/reactants and endogenous reactants of the coffee or the non-coffee substrate carrier materials.

Exemplary desirable compounds of interest may be placed into 5 exemplary categories, which in each case can be further divided into subsets of related compounds that perform similar functions in the finished beverage, as follows:
1. Flavor/aroma compounds: volatile molecules responsible for the flavor and aroma of coffee. Within the aroma category, important subcategories may include:
   Thiols: roasted, sulfury
   Pyrazines: roasted, earthy
   Diacetyl: buttery
   Furanones: caramel
   Guaiacols: Smoky
   Terpenes: Flowery
   Phenyls: Honey, fruity
   Phenols: Phenolic, ashy
   Esters: Fruity
2. Taste compounds: generally non-volatile molecules that interact with taste receptors to provide sweetness, acidity, bitterness, saltiness and umami.
3. Colorants: molecules that provide the desired color for the beverage. Generally these are chosen to result in an overall brown, low turbidity appearance though this is not a stringent requirement.
4. Texture modifiers: compounds that modify the rheology of the liquid to better match the mouthfeel of coffee.
5. Bioactivity effectors: compounds providing beneficial effects, such as caffeine for alertness or polyphenols for their antioxidant quality.

Often a family of compounds, rather than specific compounds, is relevant due similarity of the aroma of compounds with similar structure. The combinations of these compounds present in roasted coffee and coffee beverages is what tends to provide the distinctive coffee aroma/flavor. According to aspects of the invention, the disclosed cross-Maillardization methods and coffee-substitute compositions produce some, many, most or all, of these compounds. In the methods and compositions, individual components may be combined to yield the overall profile desired to create the coffee-substitute product.

Exemplary embodiments of the invention, therefore, encompass coffee and/or coffee-substitute compositions and methods for making same, based on integrating (e.g., cross-reacting) exogenous reagent(s) into alternate raw materials (coffee, or non-coffee substrate carrier materials) having endogenous chemically reactive groups. The methods solve a long-standing problem in the art of how to optimally integrate, chemically and organoleptically, exogenous ingredients/reagents into such substrate carrier materials to provide modified substrate carrier materials having cross-reaction products (e.g., cross-Maillardized substrate carrier materials). According to aspects of the present invention, direct cross-reaction (e.g., cross-Maillardization) products may either be coffee and/or coffee-like components per se, and/or may act as reactive intermediates that lead to indirect formation of other coffee and/or coffee-like components. Additionally, and/or alternatively, the present applicants have found that direct or indirect cross-reaction (e.g., cross-Maillardization) products may function by augmenting, or modulating (increasing or decreasing) the amount of one or more endogenous components (e.g., 2,5-dimethylpyrazine (2,5-DMP); 2,3-butanedione, etc.) that may be present or generated in some amount even during substrate carrier material processing in the absence of any exogenous reagent(s) (e.g., by altering of one or more chemical reaction pathways governing production of such endogenous components).

Aside from cross-Maillaridization reactions, other types of cross-reactions may include caramelization and pyrolysis at higher temperatures. Constituents or reaction products may furthermore cross-react with polyphenols and the corresponding chinones. Radical reactions may take place (e.g., as is well known in lipid oxidation), and the reaction products may cross-react as well with other molecules from Maillard reaction cascades. Maillard-reactive constituents may include hydroxyl groups of polysaccharides, and carbonyl and amino groups of the nitrogen source (e.g. amino acids, polypeptides and proteins) as well as other chemical functions know to occur in the side chain of the N-source (e.g. sulfhydryl, amino, carboxyl, amide, and others). They may decompose, preferably upon thermal treatment, resulting in smaller, often more reactive intermediates favoring further cross reactions, referred to as the Maillard reaction cascade. These Maillard-reactive constituents may cross react with components originating from other reactions (e.g. lipid oxidation, polyphenol oxidation, hydrolysis, caramelization, pyrolysis, Fenton reaction, and others).

By varying the relative concentrations and types of exogenous reagents relative to different substrate-specific endogenous reactants (e.g., by varying the relative proportion and types exogenous Maillard reactants relative to endogenous Maillard reactants), different proportions of cross-reaction products relative to endogenous or modulated endogenous reaction products (e.g., of cross-Maillard products relative to endogenous or modulated endogenous Maillard products) may be achieved. The disclosed methods, therefore, can not only be broadly applied to many different substrate carrier materials having different endogenous components and chemistries, but may also be fine-tuned based on their substrate-specific chemistries and the desired organoleptic qualities/characters. As described below in working Examples 9, 10, and 12, application of the disclosed cross-Maillardization methods to different substrate carrier materials, can be used to either differentially increase or differentially decrease levels of 2,5-dimethylpyrazine, 2,3-butanedione, or 1,3-bis[(5S)-5-amino-5-carboxypentyl]-4-methyl-1H-imidazol-3-ium, respectively, depending on the substrate carrier material.

While not being bound by mechanism, the cross-reaction (e.g., cross-Maillardization) methods are surprisingly effective in providing non-coffee compositions (and cross-reacted coffee compositions) that more accurately recapitulate the true coffee experience by reproducing some, many, most, or all of the aroma, taste, appearance, and texture of conventional/traditional coffee.

The cross-reacted substrate carrier materials (e.g., cross-Maillardized substrate carrier materials) and/or extracts thereof, can be optionally combined with yet additional ingredients (e.g., dry, wet, gums, flavors, etc.) to provide finished coffee and/or coffee-substitute compositions and precursors (e.g., extractable cross-Maillardized substrate carrier materials (solids, grounds, whole seeds, restructured coffee-like ‘beans’ and the like), and extracts, beverages, concentrates, instantized solid formulations, flavors, etc., based thereon). In preferred embodiments of the cross-reacted (e.g., cross-Maillardized) substrate carrier materials and/or extracts thereof, etc., there are no coffee beans nor coffee-bean derived ingredients, and yet they replicate traditional coffee with greater fidelity than previously achievable. In additional embodiments, the organoleptic qualities of a flawed or low-quality coffee substrate, may be substantially improved by application of the disclosed cross-reaction methods. Such cross-reacted (e.g., cross-Maillardized) and/or regenerated conventional coffee substrate materials, for purposes of the present invention, may also be considered as coffee-substitutes, or cross-reacted coffee substrates (e.g., cross-Maillardized coffee substrates).

The cross-reacted (e.g., cross-Maillardized) substrate carrier materials (e.g., coffee-substitute beverage precursors) are versatile, and not limited in the type of coffee-substitute beverage producible therefrom. Embodiments of the invention encompass compositions containing one or more of the cross-reacted (e.g., cross-Maillardized) substrate carrier material-derived compositions suitable for use as a coffee and/or coffee-like flavoring in other food or beverage items, such as ice creams, bakery items, sauces, etc. Embodiments of the cross-reacted (e.g., cross-Maillardized) substrate carrier material-derived compositions encompass blends thereof (e.g., in packaged forms) for use, for example, in flavorings, ice creams, sauces, bakery items, and the like. Embodiments of the invention also encompass cross-reacted (e.g., cross-Maillardized) substrate carrier material-derived compositions in single-use packaging (such as, for example, single or multiple use coffee pods, single-serve capsules, and the like) used for on-demand beverage production.

Process for Preparing Cross-Reacted Coffee and Non-Coffee Substrate Carrier Materials (e.g., from Raw, Non-Cross-Reacted Materials)

Various generalized ingredients and methods necessary to create the inventive compositions are described herein. Exemplary raw materials (discussed more fully in the next sections) used to produce the building blocks for the above-described cross-reacted (e.g., cross-Maillardized) substrate carrier material-derived compositions include plant or plant-derived materials that can take many forms, such as seeds/kernels/pits (e.g., date seeds, seeds from the mustard family (Brassicaceae), watermelon seeds, pumpkin seeds, Jerusalem artichokes, sesame seeds, cereal and non-cereal grains, and/or coffee (e.g., beans/cherries, grounds), and the like), leaves/stems/stalks/flowers (e.g., yerba mate stems and/or leaves, honeysuckle, and the like), shells (such as, for example, sunflower, and the like), roots (such as, for example, chicory, dandelion, and the like), extracts derived from the above, and other plant materials and derivations from plant materials, and the like.

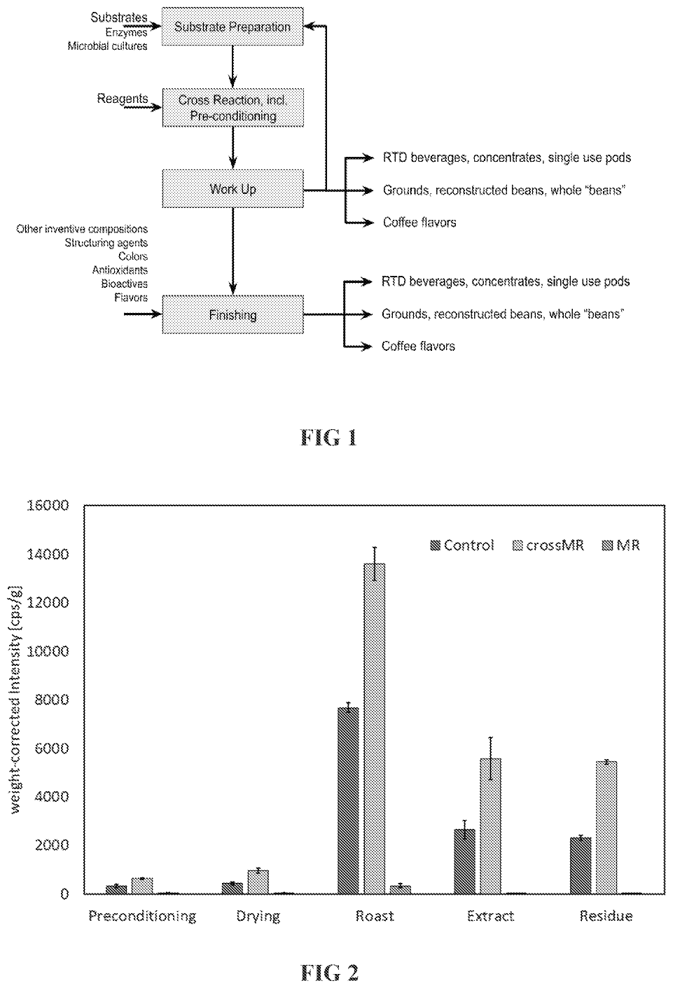

The raw materials may be transformed into the desired cross-reacted products by a multi-step process, as depicted in the exemplary process embodiment of FIG. 1, which typically involves one or more of the following exemplary steps:

1. Pre-treatment (substrate processing by, e.g., cleaning, mechanical processing, enzymatic treatments, and the like);

2. Cross-reaction (e.g., cross-Maillardization); including preconditioning;

3. Work up of cross-reaction (e.g., cross-Maillardization) product by, e.g., separation, draining, extraction, concentration, mechanical processing and the like;

4. Optional replication of one or more of steps 1-3, perhaps using alternative reagents, processing conditions, etc., (e.g., if the intermediate result or material (e.g., grounds or extracted grounds) is itself a precursor to a desired final composition); and

5. Final preparation and formulation steps (finishing steps) to form a completed/finished product component. Such steps may include, for example, mechanical processing (e.g., grinding, milling, crushing, compressing, etc., or otherwise restructuring), incorporation of ingredients (e.g., for texture, flavor, etc.), thermal processing, forming, and packaging.

In practice for step 1, if required, one or more coffee substrates, and/or one or more non-coffee substrates (substrate carrier materials) selected from the exemplary “Raw Materials” section (see below) may be optionally subjected (either separately or together, in the case of more than one substrate) to one or more pre-treatment processing steps (e.g., as described below). These pretreatment step(s) primarily serve to prepare the raw materials for the cross-reaction that occurs next. For example, residual date flesh may be removed from date kernels prior to subjecting date kernels to step 2.

In practice, for step 2, the coffee and/or non-coffee substrate carrier material is conditioned with one or more exogenous reagents, (e.g., through cross-Maillardization reaction(s)) to produce and functionally integrate chemical and organoleptic coffee-like components through cross-reactive processes (e.g., Maillard reactions) occurring between the exogenously introduced reagents/reactants and endogenous reactants of the coffee and/or non-coffee substrate carrier material. Surprisingly, using the methods disclosed herein, the cross-reaction products replicate traditional coffee-like tastes, aromas, colors, and textures with greater fidelity than previously achievable.

In the methods, substrate carrier materials may initially comprise a significant percentage, e.g., at least 5%, at least 10%, at least 20%, at least 30%, at least 40%, at least 50%, at least 60%, at least 70%, at least 80%, at least 90%, or at least 95% of the dry matter of the total preconditioning reaction mixture. In the methods, mass ratios of added Maillard-reactive carbohydrate constituent:added Maillard reactive nitrogen constituent may be any value(s), e.g., in the range of 1:20 to 20:1, 1:5 to 10, 1:2 to 5:1, or 1:2 to 2:1, or other suitable value.

Clauses 1-73 (listed above under “SUMMARY . . . ”) describe aspects of the cross-reaction methods in greater detail. In brief, by applying different conditions of water activity (a_{w}) and temperature, different cross-reactions may be sequentially used to produce and functionally integrate chemical and organoleptic coffee-like components. For example, an initial conditioned substrate carrier material may comprise a high water activity cross-Maillardized substrate carrier material (HWACMP) having cross-Maillard reaction products formed at a a_{w} value greater than that resulting from subsequent adjustment of the a_{w} of the conditioned substrate carrier material to a value less than that of the conditioning reaction.. Subsequent to pre-conditioning (also referred to herein as “conditioning”), the a_{w} of the conditioned substrate carrier material may be adjusted to a value less than or equal to e.g., 0.85 (or, e.g., to less than or equal to another exemplary value as recited in clauses 12, 52 and 65) under conditions sufficient provide a low water activity (low a_{w}) cross-Maillardized substrate carrier material (LWACMP) having further cross-Maillard reaction products formed by the reaction between the exogenous Maillard reagent, and the endogenous Maillard-reactive constituent(s) (e.g., see above clauses 1-15). The LWACMP may be heated under conditions sufficient (e.g., wherein the heating is at one or more temperatures greater than the temperature used for adjusting the a_{w} of the conditioned substrate carrier material) to promote further Maillardization thereof, to provide an elevated temperature, cross-Maillardized substrate carrier material having cross-Maillard reaction products (ET-LWACMP) (e.g., see above clauses 16-20).

As indicated above, other types (other than cross-Maillardization) of cross-reactions may include caramelization and pyrolysis at higher temperatures. Constituents or reaction products may furthermore cross-react with polyphenols and the corresponding chinones. Radical reactions may also take place (e.g., as well known in lipid oxidation), and the reaction products may cross-react as well with other molecules from the Maillard reaction cascade(s).

In practice, for step 3, the conditioned substrate carrier material, the LWACMP or the ET-LWACMP may, for example, be ground and/or extracted to provide an extract, and an extracted retentate substrate carrier material (e.g., see above clauses 21-25).

In practice, for step 4, after working up the initial cross-reactions product(s), the resulting materials may be subjected to additional runs of one or more of the preceding steps 1-3, e.g., using alternative reagents, processing conditions, etc.

In practice, for step 5, after the final workup step, the product(s) are assembled in their final form (finished) (e.g., see above clauses 26-34).

Raw Materials

Exemplary Substrate Carrier Materials:

Exemplary grain/cereals and pseudo cereals: corn, maize, oat, barley, rye, wheat, millet, sorghum, tiger nut, rice, quinoa, amaranth, buckwheat, and the like, and including the following exemplary cereal grains:

Poaceae family, such as Zea mays (corn, resp. maize), Avena sativa (oat), Hordeum vulgare (barley), Secale cereal (rye), Triticum aestivum (wheat), Pennisetum glaucum (millet), and Sorghum sp. (sorghum), Cyperus esculentus (tiger nut), or species of the Oryza genus (rice), f.e. Oryza glaberrima, Oryza sativa, and the like;

Amaranthaceae family, such as Chenopodium quinoa (quinoa), Amaranthus (amaranth), and the like; and

Polygonaceae family, Fagopyrum esculentum (buckwheat), and the like;

Exemplary roots: Chicory, artichoke, sunflower, Jerusalem artichoke, dandelion, Chinese artichoke, ginger, and the like. These include the following exemplary roots/part of roots or seeds;

Asteraceae family, such as Cichorium intybus (chicory), Cynara scolymus (artichoke), Helianthus annuus (sunflower), Helianthus tuberosus (Jerusalem artichoke), Taraxacum officinale (dandelion), and the like;

Lamiacemae family, Stachys affinis (Chinese artichoke), and the like; and

Zingiberaceae family, Zingiber officinale (ginger), and the like;

Exemplary fruits, seeds, and shells thereof: Sunflower, date, palm, okra, cocoa, pumpkin, hemp, coffee, ramon tree, fig, soy, milkvetch, lupine, pea, peanut, avocado, olive, hazelnut, acorn, cherry, apricot, plum, raspberry, walnuts, hickory, pecan nut, chestnuts, Orange, lemon, grape, sesame, and mustards, and the like, and including the following exemplary fruits, seeds and shells thereof;

Persea family, such as Persea americana (avocado); and the like

Asteraceae family, Helianthus annuus (sunflower), and the like;

Arecaceae family, Phoenix dactylifera (date), Elaeis sp. (palm), and the like;

Malvaceae family, Abelmoschus esculentus (okra), Theobroma cacao (cocoa), and the like;

Cucurbitaceae family, Cucurbita pepo (pumpkin), C. maxima, C. argyrosperma, C. moschata, and the like;

Cannabaceae family, Cannabis sativa (hemp), humulus (hops), and the like;

Rubiaceae family, in specific, seeds and fruits of the Coffea genus, and the like;

Moraceae family, Brosimum alicastrum (Ramon seed), Ficus carica (fig), and the like;

Fabaceae family, Glycine max (soy), Astralagus boeticus, Lupinus pilosus (blue lupine), Pisum sativum (pea), Arachis hypogaea (peanut), and the like;

Oleaceae family, Olea europaea (olive), and the like;

Fagaceae family, Corylus sp. (hazelnut), Quercus sp., Lithocarpus sp. (acorn), and the like;

Rosaceae family, in specific Prunus sp. and subsp., Prunus dulcis (almond), Prunus avium (sweet cherry), Prunus cerasus (sour cherry), Prunus subg. Prunus and their cultivars, Prunus armeniaca (apricot), Prunus domestica subsp. Insititia (plum), Rubus subgenus Idaeobatus (raspberry), and the like;

Juglandaceae family, Juglans regia (walnuts), Carya sp. and subsp. (hickory and pecan nut), and the like;

Betulaceae family, Castanea sp. (chestnuts), and the like;

Rutaceae family, Citrus sinensis (orange), Citrus x limon (lemon), and the like;

Vitaceae family, Vitis vinifera (grape), and the like;

Brassicaceae family, Sinapis alba (yellow mustard), Brassica hirta (white mustard), Brassica nigra (black mustard), Brassica oleracea and rapa (cabbages), and the like;

Leaves and stems: Tea, yerba mate, artichoke, and the like. These include the following exemplary leaves and/or stems;

Aquifoliaceae family, Ilex paraguariensis (yerba mate), and the like;

Theaceae family, Camellia sinensis (tea), and the like; and

Asteraceae family, such as Cynara scolymus (artichoke), and the like.

And including the Coffea family, such as Coffea arabica, Coffea canephora (Robusta), and the like.

### Exemplary Exogenous Reagents

Sugars:
a) Exemplary monosaccharides (and their corresponding salts (e.g., phosphates)), including but not limited to the following ketoses and aldoses, and the like.
   i. Ketoses
      1. Trioses, such as dihydroxyacetone
      2. Tetroses, such as erythrulose
      3. Pentoses, such as ribulose, xylulose
      4. Hexoses, such as fructose, psicose
      5. Heptoses, such as sedoheptulose, mannoheptulose
   ii. Aldoses
      1. Trioses, such as glyceraldehyde
      2. Tetroses, such as erythrose, threose
      3. Pentoses, such as ribose, arabinose, xylose
      4. Hexoses, such as glucose, mannose, galactose
      5. Heptoses, such as glucoheptose, mannoheptose, galactoheptose
b) Exemplary deoxysaccharides, such as rhamnose, fucose, deoxyribose, and the like.
c) Exemplary disaccharides, such as sucrose, maltose, lactose, lactulose, trehalose, cellobiose, isomaltulose, isomalt, and the like.
d) Exemplary oligosaccharides, such as fructooligosaccharides, galactooligosaccharides, maltotriose, and raffinose, dextrins, and the like.
e) Exemplary polysaccharides, such as dextrins, starch, inulin, cellulose, arabinogalactan, galactomannan, amylose, pectins and depolymerized pectins, glycosides and the like.
f) Exemplary degradation products
   i. Deoxyosones and didesoxyosones, such as 1-desoxyosones and 3-desoxyosones, and the like.
   ii. Furanones, such as 4-hydroxy-5-methyl-3(2H)-furanone (norfuraneol), 4-hydroxy-2,5-dimethyl-3(2H)-furanone, 2-methyl-4,5-dihydro-3(2H)-furanone, and the like.
   iii. Pyranones, such as maltol, 5-hydroxy-5,6-dihydromaltol, and the like.
g) Exemplary uronic acids, such as galacturonic acids, glucuronic acids, and the like.
h) Exemplary polyols, such as arabitol, glycerol, polyitol, xylitol, sorbitol, and the like.
i) Exemplary amino sugars, such as galactosamine, glucosamine, and the like.
j) Exemplary sugar syrups, such as aqueous solutions of the named above and their corresponding thermal processed products, such as caramelized sugar syrups, and the like.
k) Exemplary raw and processed agricultural products, including the products of their fermentations, and including but not limited to the following exemplary products:
   i. Ingredients, such as hydrolyzed starch (e.g. hydrolyzed corn starch), processed syrup (high fructose corn syrup, glucose syrup), molasses, malt extract, and the like.
   ii. Fruit juice, such as those derived from apples, plum, cranberries, lime, lemon, orange, grape and/or currant, and the like.
   iii. Syrups, such as those derived from maple, date, coconut, rice and/or agave, and the like.
   iv. Honey, invert sugar, and similar products.
   v. Extracts or hydrolysates of foods high in carbohydrates, such as extracts or hydrolysates of sugar beet, sugar cane, maize, bananas, apples, and the like.
   vi. Extracts or hydrolysates of grains, such as malt extracts, and the like.
   vii. Soft drinks, such as lemonades, cola, root beer, ginger ales, and the like.
   viii. Dairy and dairy products, such as milk, and similar products.
   ix. Plant-based milk analogues, such as soymilk, oat milk, nut milk, pumpkin seed milk, and the like.
   x. Pulps derived from food processing of fruits and vegetables, such as Coffea fruits and seeds, apple pulp, orange pulp, and the like, as well as pomace and must.

### Exemplary Amino Acids

a) Amino acids and their derivatives, e.g. modified by acetylation etc., may comprise or be derived from one or more of alanine, cysteine, aspartic acid, glutamic acid, phenylalanine, glycine, histidine, isoleucine, lysine, leucine, methionine, asparagine, pyrrolysine, proline, glutamine, arginine, serine, threonine, selenocysteine, valine, tryptophan, tyrosine, selenomethionine, hydroxyproline, ornithine, and the like, alone or in any combination or subcombination.

b) Peptides, such as dipeptides, oligopeptides and/or polypeptides, derived by synthesis, isolation, chemical and/or thermal hydrolysis, enzymatic digestion/polymerization/crosslinking, and the like.

c) Protein and protein hydrolysates or the products of their fermentations
i. Derived from animal products, such as meat, dairy, eggs and/or connective tissues, and the like.
ii. Derived from plant materials, such as soy, pea, pumpkin, rice, oat, chickpeas, almonds, hemp, wheat, and the like.
iii. Saccharide-protein conjugates, such as glycoproteins, and the like.
iv. Oil-protein conjugates, such as proteolipids.

d) Other glycosidically-bound secondary metabolites, and the like.

### Exemplary Modifying Agents and Intermediate Products

a) Reactive precursors and intermediates, such as Amadori and Heyns compounds, and the like.

b) Initiators such as aldehydes and ketones (e.g., glyoxal, methylglyoxal, glycolaldehyde, acetol, dihydroxyacetone), and the like.

c) Carbonic acids, such as ascorbic acid, lactic acid, pyruvic acid, acetic acid, citric acid, tartaric acid, quinic acid, and the like. For purposes of the present invention, the amount of α-hydroxy carboxylic acid(s), if used in the cross-reactions mixture(s), preferably is less than 10% by weight.

d) Additives and agents
i. Reducing agents, e.g. sodium hydrosulfide, ascorbic acid, and the like.
ii. Antioxidants, e.g., ascorbic acid and [poly]phenols (see item f below), and the like.
iii. Catalytic minerals and mineral salts, such as sodium chloride, sodium sulfate, iron chloride, and copper sulfate, and the like.
iv. pH-modifiers and buffering agents, such as acids and their corresponding salts (phosphoric acid, lactic acid, acetic acid, and sodium acetate etc.) or bases, such as carbonates and phosphates (ammonia, potassium or sodium phosphates and carbonates, sodium hydrogen phosphate, potassium hydrogen phosphate, sodium bicarbonate), and the like.

e) Solvents, such as ethanol, hexane, glycol or polyethylene glycol, and the like.

f) Phenols and their corresponding esters, such hydroxycinnamic acids, e.g. coumaric, ferulic and/or caffeic acid, and their corresponding esters with e.g., quinic acid, and the like; including, in particular, chlorogenic acid and the corresponding isomers, and/or feruloyl quinic acid derivatives (e.g., as may be sourced from hops), and the like, as well as the conjugates with saccharides thereof, such as glycophenolic compounds, and the like.

g) Polyphenols, such as quercetin, epicatechin, lignans, lignin, flavonoids, and the like.

h) Drying agents, such as calcium chloride, potassium carbonate, sodium sulfate, and the like.

i) Surfactants, such as phospholipids, saponins, Acacia gum, mono and diglycerols, propylene glycol esters, lactylated esters, polyglycerol esters, sorbitan esters, ethoxylated esters, succinated esters, fruit acid esters, acetylated mono- and diglycerols, phosphated mono- and di-glycerols, sucrose esters, and the like.

j) Enzymes for breaking down larger components (such as, for example, hydrolases, lyases, and the like), forming larger components (such as, for example, ligases, polymerases, and the like), modifying (such as, for example, transferases, oxidoreductases, and the like), isomerization (such as, for example, isomerases, and the like), and the like.

Substrate Preparation Prior to the reaction step, raw material substrates (i.e., the coffee and/or non-coffee substrate carrier material) can be treated by a variety of processes to prepare the materials for the cross-reaction step 2 (see above general “Process for preparing cross-reacted non-coffee substrate carrier materials”). Depending on the particular substrate carrier material, any combination of one or more of the following processes can be used in any order. In general, these methods are designed to remove undesirable material from the substrate carrier materials, liberate, or render accessible, useful substrate materials from the matrix of the substrate carrier material, or improve the contact or reactivity between exogenous reagents and the substrate carrier materials with which they can react.

Cleaning and Sorting

Substrate carrier materials may require removal of foreign matter, undesirable units (such as, for example, poor quality materials), contaminated units of portions thereof, or residual flesh. Sorting based on criteria important for the subsequent reaction can also be carried out. Such criteria non-exclusively include size, color/coloration, density, geometric factors (such as, for example, aspect ratio), and the like.

Washing/Extracting

Substrate carrier materials may require a solvent-based treatment step to remove certain undesirable components or compounds prior to the cross-reaction (e.g., cross-Maillardization reaction). This can be for a variety of reasons. These components/compounds could produce undesirable reaction products under subsequent reaction conditions (such as, for example, oils that may go rancid), or may themselves be a desirable product to extract before the cross-reaction (e.g., cross-Maillardization reaction) can alter them (such as, for example, caffeine). Other possibilities include avoiding or modulating interference with the cross-reaction (e.g., cross-Maillardization reaction). This could take the form of modulating (increasing or decreasing) or eliminating compounds that suppress or compete with desired reactions (such as, for example, undesirable sugars), or components like skins or structural materials that inhibit penetration of the reagents into the body of the substrate carrier materials that can be removed chemically and/or physically.

Thermal Processing

Thermal processing may be necessary to properly prepare substrate carrier materials for the cross-reaction (e.g., cross-Maillardization reaction). Examples include the thermal inactivation of undesirable microbial populations or enzymes that would produce undesirable products if left functional. Thermal processing may also be used to alter the structure or composition of the raw material to make it more suitable for subsequent cross-reaction (e.g., cross-Maillardization reaction). This may include, for example, steaming, blanching, roasting, freezing, dehydrating, or lyophilizing, or the like, to disrupt cellular structures thus allowing easier penetration of reagents. Furthermore, it may convert the substrate carrier material to one more favorable for subsequent cross-reaction when the exogenous reagents are added (e.g., exogenous Maillard reagent(s)).

Methods for thermal treatment may include any approach appropriate for the desired result, demands of the process, and details of the samples. This may, for example, include exposure to increased or decreased temperatures relative to ambient.

Mechanical Processing

The structure of the substrate carrier material(s) may be unsuitable for subsequent processing. Various mechanical treatments could be used to prepare them, such as comminution (e.g., milling, dicing, and the like), peeling, polishing, cracking/crushing, pressing (such as to remove oils or juices), sonication, perforating, and the like.

Modified Atmosphere Processing

Substrate carrier material(s) may be treated with a vacuum/low pressure environment to remove undesirable compounds or to collect those that should not participate in the cross-reaction. These conditions may also be used to de-gas and/or dehydrate the substrate carrier material or aid in the infusion of reagents to the inner structures of the substrate carrier material.

Alternatively, substrate carrier material may be subjected to high pressures. These may, for example, be for purposes of microbial or enzyme inactivation, to modify the structure of the substrate carrier material to enhance subsequent processing, to aid in the infusion of exogenous ingredients for subsequent steps, or to aid extraction of compounds/components not desired in the cross-reaction.

Additionally, these environments can be comprised of specific gas mixtures, rather than air. These may be chosen for their biochemical impact, for example to speed ripening (e.g. ethylene, and the like) or to prevent oxidation (such as, for example, from inert N₂, CO₂, and the like). Additionally, these may be gases that are themselves reagents in subsequent steps.

Finally, the humidity may be modified to prepare the substrate carrier material. This may include elevated levels to hydrate plant tissues, or reduced humidity to dry and eliminate undesired water (e.g., to adjust the water activity (a_{w})).

Cycling of these various conditions may be desirable and applied. This may include, for example, a vacuum infusion step to displace trapped air, followed by high pressure to enhance the diffusion. Alternatively, cycles of rapid pressurization/depressurization can be used to modify the structure of the substrate carrier material.

Immersion

Substrate carrier materials can be exposed to compositions including additional reagents prior to the cross-reaction (e.g., the cross-Maillardization reaction(s)). This may be for purposes of maximizing contact between the materials in the substrate with the exogenous reagents they are to react with (e.g., delivering sugars and/or amino acids to the center of an intact seed). Such exposure could take the form of immersion in liquid solutions or vapor mixtures under a variety of conditions as described herein in the above “Modified Atmosphere Processing” section.

Photonic Treatments

Continuous or pulsed photonic treatments may be used to reduce microbial levels or to modify the surface, inner structure, or chemistry of the substrate carrier materials and/or added reagents.

Enzymatic Treatments

Endogenous or exogenous enzymes may be used to further modify the substrate carrier material prior to cross-reaction processing (e.g., cross-Maillardization). Enzymes may be used to break down polymers to liberate particular reagents (e.g., by use of amylases or hemicellulases to release a simple sugar), to soften, solubilize or break down the structure of the substrate carrier material (e.g., by use of cellulases, and the like), or to separate skins/membranes (such as, for example, pectinases, and the like). Similarly, peptidases could be used to either liberate useful components for reactions, increase solubility/availability or to break down the structure of the substrate (such as, for example, to increase porosity, ease or facilitate milling, etc.). Lipases are an additional exemplary class of enzyme that may aid in the production of useful precursors or functional ingredients, or in modifying the structure for the sub sequent cross-reaction (e.g., cross-Maillardization). Additionally, enzymes that modify particular components of the substrate carrier material without specifically liberating them (e.g., deaminating asparagine to produce aspartic acid and reduce the production of acrylamide) may be used.

Sprouting

Seeds may be used as substrate carrier material, or may be sprouted and carried to the desired level of plant maturity to enact desired changes within the seed, such as conversion of storage carbohydrates to simple sugars, the attenuation of relevant antinutritional factors, etc. Sprouts may be thermally treated or dried at this point to halt or inactivate the biochemical processes and/or to inactivate any microbial species present.

Fermentation

Prior to cross-reacting (e.g., cross-Maillardization), the substrate carrier material(s) may be modified by a fermentation step. This may comprise fermentation of a relatively crude form of the substrate carrier material prior to washing, such as, for example, a mass of crushed fruit pulp and intact or fractured seeds, or a relatively processed form of the substrate carrier material, such as a steamed grain with high internal moisture content and compromised cell structure. The organisms to perform the fermentation could be native or inoculated onto the substrate. Organisms could be, for example, bacterial or fungal. Such organisms may be genetically modified to enhance their production of key components or to produce compounds not native to the organism.

Such fermentation processes may be used, for example, to convert native substrate to a more usable form (e.g., microbial liberation of simple sugars or amino acids, and the like). Such fermentation processes may also be used to generate useful enzymes for subsequent steps, e.g., for developing flavors, or flavor precursors.

Process control for such fermentations may be accomplished through the use of conventional bioreactors. Completion of the fermentation step may include an inactivation step, such as, for example, a thermal treatment or antimicrobial ingredient addition.

Cross-Reaction (e.g., Cross-Maillardization Reaction)

The cross-reaction (step 2 of the multi-step process depicted in the exemplary process embodiment of FIG. 1) is an important step in the creation of the desired final products from the coffee and/or non-coffee substrate carrier materials and the exogenous reagents (e.g., exogenous Maillard reagent(s)). According to particular aspects of the invention, given the nature and complexity of flavor-forming reactions (e.g., of Maillard reactions), the specific compositions, concentrations, and process parameters are useful to control or direct the cross-reaction towards the efficient creation of desired compounds. As discussed above, direct cross-reaction (e.g., cross-Maillardization) products may either be coffee and/or coffee-like components per se, and/or may act as reactive intermediates that lead to formation of other indirect coffee and/or coffee-like components. Additionally, and/or alternatively, the present applicants have found that direct or indirect cross-reaction products (e.g., direct cross-Maillardization products or products derived from or including the direct products) may function by augmenting, or modulating (increasing or decreasing) the amount of one or more endogenous components (e.g., 2,5-dimethylpyrazine; 2,5-DMP) that may be present or generated in some amount even during substrate carrier material processing in the absence of any exogenous reagent(s) (e.g., by altering of one or more chemical reaction pathways governing production of such endogenous components). By varying the cross-reaction conditions, and the relative concentrations and types of exogenous reagents relative to different substrate-specific endogenous reactants (e.g., by varying the relative proportion and types exogenous Maillard reactants relative to endogenous Maillard reactants), different proportions of cross-reaction products relative to endogenous or modulated endogenous reaction products (e.g., of cross-Maillard products relative to endogenous or modulated endogenous Maillard products) may be achieved. The disclosed methods, therefore, can not only be broadly applied to many different coffee and/or non-coffee substrate carrier materials having different endogenous components and chemical pathways, but may also be fine-tuned based on their substrate-specific chemistries and the desired organoleptic qualities/characters. As previously mentioned, cross-reactions may also include, but are not limited to, reactions with phenols/chinones, lipid degradation products, and reactions with other (plant) constituents. Overall, cross-Maillard reaction products may further react with molecules resulting from caramelization, pyrolysis, lipid and (poly)phenol oxidation, and the like.

During the cross-reaction step, ingredients, for example, from the Raw Materials section (e.g., one or more substrate carrier materials, and particular exogenous reactants) may be combined in any suitable means, blended with solvents (including water) appropriate to the nature of the cross-reaction and thermal processes, and adjustment of water activity may be employed and the cross-reactant products formed in one or more appropriate reaction vessels—which one or more reaction vessels could optionally be a final packaging form—as dictated by the necessary conditions of the cross-reaction.

Various factors may be used as controls in the production of the cross-reaction products/compositions. A particular cross-Maillardization product may be intermediate or a final, finished product. Generally provision of final products will involve workup and final assembly steps to produce finished products. In particular aspects, the cross-reaction could produce a finished product if one or more of following exemplary conditions are satisfied: reaction media are loaded into heat-stable, chemically inert packaging prior to reacting; the substrate carrier material and exogenous reagents require no further processing after the cross-reaction; and thermal processes sufficient to render a safe product, given the product characteristics and format, are utilized in the reaction.

In these cases, the packaging may serve as the reaction vessel. Some examples of types of products (e.g., cross-Maillardized substrate carrier materials, and extracts thereof) that may be produced from such an operation include but are not limited to the following: ready-to-drink (RTD) beverages in a can or bottle, perhaps as a concentrate; single serve pods; ‘grounds’ for subsequent extraction by the user, in a can/jar or similar vessel; intact or restructured seeds/kernels/beans for grinding and extraction by a user, in a can, jar or similar or suitable vessel; liquid or powdered flavors in, for example, glass bottles.

Temperature & Time

Temperature control may be used to control the production rates of desired cross-reaction products and to limit microbial concerns. Reaction times (e.g., the cross-Maillardization reaction times) and temperatures may be varied to achieve the desired results (e.g., desired chemical and/or organoleptic properties imparted to the substrate carrier materials and/or to extracts thereof). Particular reaction temperatures may favor specific cross-reactions and cross-reaction products and may be selected according to the results desired. Additionally, multiple temperature steps may be used, based on the particulars of a given cross-reaction and substrate carrier material.

In general, cross-reactions (e.g., cross-Maillardization) in aqueous media may be conducted at temperatures from, e.g., 0° C. to 170° C. (e.g., from 55° C. to 170° C., from 55° C. to 125° C., etc.), with temperatures in excess of 100° C. typically requiring above ambient pressure. Reactions in ostensibly dry conditions will typically occur, at least partially, at higher temperatures, e.g., above 170° C. To facilitate the incorporation or use of certain reagents, for example, unstable or highly reactive ones, low temperature steps, including those below 0° C. may be incorporated into the cross-reaction methods. Time-varying temperature profiles are desirable in many situations, such as in the roasting of solids or in multi-step reactions. These temperature changes may be timed according to other reaction parameters, such as ingredient additions, pH changes or sufficient progress in a given reaction or cross-reaction (e.g., cross-Maillardization reaction(s)).

Cross-reactions (e.g., cross-Maillardization) may also occur during drying (reducing the overall a_{w}), which may, for example, be conducted at temperatures from 0° C. to 130° C. Drying, for example, may comprise heating of a moist conditioned carrier material (e.g., in an electric oven, roaster, etc.), at temperatures from about 90° C. to about 130° C., from about 40° C. to about 90° C., from about 50° C. to 70° C., etc.

Cross-reactions (e.g., cross-Maillardization reactions) may occur during heating (e.g., roasting). In particular aspects, heating (e.g., roasting) of the dried conditioned carrier material may comprise roasting at one, or more temperatures in a range (e.g., ramped range), which may vary with the particular substrate carrier materials (e.g., leaves and roots, seeds, etc.), from about 110° C. to about 300° C., from about 140° C. to about 160° C.; from about 190° C. to about 225° C.; from about 170° C. to about 190° C.; about 170° C. at the maximum; about 180° C. at the maximum; about 190° C. at the maximum, etc. In particular aspects, roasting of the dried conditioned carrier material may preferably comprise roasting at one or temperatures in a range from about 180° C. to about 220° C. (e.g., from about 200° C. to about 220° C.). In particular aspects, roasting may comprise varying (e.g., ramping) the temperature from about 20° C. to about 220° C. In particular aspects, the roasting comprises varying (e.g., ramping) the temperature from about 200° C. to about 216° C.

Heat may be applied or removed in any number of suitable ways based on the form factor of the substrate carrier material(s). Non-exclusively, these include ovens and steam ovens, steaming chambers, kettles and thermal processing vessels, retorts, heat exchangers, ohmic heating devices, screw extruders, immersion cookers, jet cookers, and others as recognized in the art or foreseeable based thereon. Heat may be applied to bulk reaction mixtures or in individual containers each containing a portion of the total cross-reaction mixture. Cooling devices may include, but are not limited to heat exchangers, blast chillers, spiral freezers, etc. Agitation of liquids, solids, or final containers is optionally applied, and is typically useful.

pH

The pH of the cross-reaction may be varied for determining the products of the reaction. By setting, or changing, the pH to one or more desired value/range, the products of the reaction may change. Furthermore, the exogenous and endogenous reagents themselves (including precursors and intermediates) may be pH-sensitive and thus may require specific pH values during their introduction and cross-reaction.

Preferably, the pH for the cross-reactions (e.g., the cross-Maillardization reactions) is from about pH 5.0 to about 8.5. Particular cross-reactions, however, may involve the use of pH levels beyond (below or above) this range. Particular cross-reactions, for example, may provide a desired outcome when performed at pH 6.0-8.5, while others may involve preferred ranges from pH 2.5-5.0. Higher and lower pH values are possible, and in general, the pH should be returned to suitable ranges for food products prior to release into commerce.

pH values can be controlled, for example, through explicit addition of appropriate acids and bases so as to reach a desired pH value. As the cross-reaction can produce compounds that themselves alter the pH over time, control of the pH is a method to enhance the yield, efficiency and organoleptic qualities of the cross-reaction and its products. pH control may, for example, take the form of physical pH buffers, compositions of which were described previously, or active monitoring and control systems with metered dosing of appropriate acids and bases (organic or inorganic).

Depending on the cross-reaction and substrate carrier material, a time-dependent pH value that favors different reactions at different times may be used. This change in pH may be coordinated with the progress of certain reactions (for example, production of desired products or consumption of particular reagents), different temperature steps, or the addition of reagents at later stages.

Water Activity (a_{W})

According to particular aspects of the present invention, the water activity (a_{w}) of a cross-reaction mixture (e.g., of a cross-Maillardization reaction mixture) is useful in controlling the specific cross-reaction products generated and/or modulation of the levels of endogenous components present or produced during the cross-reaction (e.g., modulation of non-cross-reaction products or indirect cross-reaction products). Much like temperature and pH, different ranges of a_{w} may favor the production of different reaction products and/or cross-reaction products, or levels thereof.

Control of the a_{w} is may be accomplished in various ways, for example:

1) Explicit addition or removal of water by, for example, blending, diluting, conditioning, dehydrating, etc.

2) Environmental/atmospheric control during the reaction, such as by humidistatic control in the heating chamber (e.g., steam ovens).

3) Sealing of the heating chamber, thereby limiting or preventing the addition or removal of moisture from the cross-reaction mixture, as in the following exemplary embodiments:
a) sealing single—(e.g., Nespresso® K-Cup®) or multi-serve, heat-stable packaging materials after charging with all the ingredients necessary to produce a coffee-like composition;
b) an embodiment of a) in which the contents are consumed or dispensed directly from the packaging;
c) an embodiment of a) in which the contents of the packaging comprise a coffee-substitute precursor, such as a liquid concentrate that is further diluted to produce a beverage;
d) an embodiment of a) in which the contents of the packaging comprise solid materials from which a liquid (likely aqueous) extraction is performed to produce a coffee-like beverage either by manual means (e.g., by gravity/pour-over filtration), semi-automatic (e.g., grounds loaded into a conventional drip machine), or fully automatic (e.g., push button operation such as K-Cup® or Nespresso®-style single-serve vending machines);
e) an embodiment of a) in which the packaging materials are recyclable; and
f) an embodiment of a) in which the contents of the packaging is compostable/biodegradable.

Atmosphere

The atmosphere that the substrate carrier material and exogenous reagents are exposed to may be used to influence the cross-reaction products (e.g., influence the cross-Maillardization products of the cross-Maillardized substrate carrier materials and extracts thereof) produced. As previously discussed, the water activity (and thus atmospheric moisture), may be determinants of the final reaction products. Moreover, particular atmospheric components may contribute directly to the reaction. Oxygen, for example, comprises approximately 20% of the native atmosphere and can oxidize labile, flavorful components, thus producing other flavorful components (e.g., desirable and/or undesirable components), especially at elevated temperatures.

Additionally, the atmosphere may have a time-varying nature. As the cross-reaction(s) (e.g., cross-Maillardization reactions) take place, volatile components may be created that serve to both modify the composition of the atmosphere as well as alter (e.g., increase) the pressure, which changes may then influence the products of the cross-reaction(s) (e.g., cross-Maillardization reactions). Moreover, increasing (or decreasing) pressure may lead to altered product and/or cross-reaction product composition, and is thus an additional control variable in producing the desired compositions comprising cross-reaction products (e.g., cross-Maillardization products).

Atmospheric control may be accomplished in ways analogous to humidity control. For example, sealed chambers, whether large reaction vessels or single-serve end-user packaging, may be held fixed to allow native atmospheric changes to take place. The cross-reaction (e.g., cross-Maillardization reactions) in such sealed chambers, for example, could begin with a native atmosphere, or one composed of a particular gas or mix of desired gasses (e.g., comprising an inert gas such as N₂ to prevent oxidation), that will evolve as the cross-reaction proceeds.

Alternatively, process (e.g., cross-Maillardization) vessels can be subjected to vacuum conditions, vented, flushing and/or bubbling with preferred gasses, and/or pressurized by addition of a sufficient quantity of one or more desired gases, so as to arrive at the intended atmospheric condition and pressure. These and other atmospheric changes, can be controlled and time-varying to optimize or tailor the cross-reaction(s) (e.g., cross-Maillardization reactions) taking place over time.

Reagent Timing

These reactions and cross-reactions can be further optimized by delaying the introduction of certain reagents—or replenishment of consumed reagents—by later addition of additional reaction ingredients. These could be, for example, the creation of a precursor from the raw materials before adding the reagent needed to react with the precursor to produce the desired final composition.

For example, the reaction could begin with a relatively simple mixture of a substrate material rich in reducing sugar, and one or more exogenous amino acids. After production of Amadori/Heyns products from these starting materials, additional carbohydrate or amino acid sources could be added to create desired products. Alternatively, these additions can be made on a continuous basis—rather than stepwise—to maintain ideal reaction conditions. Furthermore, these additions (continuous or stepwise) could be made based on continuous monitoring of the reaction by suitable measurement or analytical techniques and adjusted to optimize conditions on an ongoing basis.

Interfaces

In some cases, reagents may be insoluble in an acceptable shared solvent. However as close contact is necessary to react two components together, one strategy to enable such reactions is to bring two insoluble phases together and drive the reaction at the interface between these two phases. A liquid biphasic system, for example, of two insoluble solvents produces a planar interface at which the reaction could take place. Alternatively, one insoluble phase could be dispersed into a continuous phase (a colloidal dispersion). Each phase could itself be solid, liquid, or gas (excepting gas-gas dispersions), perhaps stabilized by the addition of emulsifiers or other structuring agents or continuous mixing, bubbling, etc., to prevent undesirable separation. Continuous or dispersed phases could include any of the exemplary ingredients listed in the Raw Materials section, including immobilized catalysts/enzymes on solid carriers, whole or milled substrates, etc.

Work Up

After completion of the cross-reaction (e.g., cross-Maillardization reaction), in step 3 of the multi-step process depicted in the exemplary process embodiment of FIG. 1, the crude product may be treated (e.g., worked-up), and generally is treated, to convert it to a component of a finished or intermediate composition. This may include one or more optional steps, such as separation, concentration, extraction, thermal processing, and the like, which may be performed in any suitable order and combined in any suitable way to provide for the finished or the intermediate component.

The products of such workup steps may generally provide the inventive compositions, and in some cases may be essentially finished products (e.g., subjected to optional additional steps described in the next section for completion), or may be used as a component of an additional reaction or step (e.g., used as an intermediate component).

Separation

Insoluble or immiscible components may be separated by various means, such as decanting, filtration, centrifugation, and the like. Such methods may be further implemented to fractionate products based on size or density. Moreover, vacuum, high pressure, modified atmospheres, and the like may be used to aid in this process.

Extraction

Solvent or supercritical fluid extractions may be performed to remove undesirable reaction products or to isolate desirable reaction products. Such extractions may include, for example, one or more of liquid-liquid extractions, solid phase assisted extractions, chromatographic extractions/separations, and the like. A variety of conditions may be applied, including, e.g., various solvents, pHs, temperatures, contact times, and atmospheres (including pressure/vacuum), and the like.

Concentration

For liquid fractions, the overall concentration of a component can be modulated (e.g., increased or decreased) if desired. This may be accomplished by using techniques such as reverse and/or forward osmosis, nano-, ultra- or micro-filtration, solvent removal/desolventizing including lyophilization, distillation/evaporation and vacuum distillation, spray drying, extrusion, freeze concentration, and the like.

Thermal Processing

Exemplary thermal processing methods are described in the “Pre Treatment” section covering relevant processing methods.

Mechanical Processing

Exemplary mechanical processing methods are described in the “Pre Treatment” section covering relevant processing methods.

As mentioned above, optional replication of one or more of steps 1-3 of the exemplary process embodiment of FIG. 1 may be employed, perhaps using alternative reagents, processing conditions, etc., (e.g., if the intermediate result is itself a precursor to a desired final composition).

Finishing

After the workup of step 3 (and optionally step 4) of the exemplary process embodiment of FIG. 1 for creation of the inventive compositions, final assembly into a finished product may be necessary or desired as in step 5. This may include combining inventive compositions with any necessary or desired extra ingredients, as well as optional forming, packaging, and/or thermal processing to produce safe products. Exemplary products of this section include various format embodiments in accordance with the present invention, including but not limited to the following: ready-to-drink beverage; grounds in a capsule or other single usage pack or a concentrate for dilution by the end-user; instantized granules or powders; grounds for general usage; constructed beans or other formed solids in both reacted (“roasted”) and unreacted (“green”) forms; and intact coffee-substitute “beans” derived from intact or fragmented processed substrate materials (e.g., to be ground and extracted by an end user).

Formulation

Individual inventive compositions (e.g., products derived directly or indirectly from the cross-reactions, e.g., cross-Maillardization reactions) may be combined with other inventive compositions or with other ingredients necessary to complete the desired format. Such compositions and/or ingredients include, for example, colorants, flavors, texture and pH modifiers, functional ingredients, nutritional and bioactive ingredients, plant or animal milks in various formats (liquids, dry powders, etc.), and the like. Depending on the format of the desired finished product, solid or liquid forms of the above may be used.

The composition(s) may be processed into grounds, such as in a single serve packaging, or single or bulk packed loose grounds or a formed product, and for these purposes, may be further blended with a carrier-type material. For example, upcycled plant materials not previously processed using the disclosed reaction scheme may be used as a carrier matrix for the inventive compositions and other ingredients and optionally with solvents if needed or preferred to produce the desired blend(s).

The compositions may be further processed to adopt a particular shape (e.g., see the “Forming/Pelletizing” section herein below), and for such purposes ingredients crucial to or desired for processing may additionally be added. For example, binders, moisture control ingredients and other materials or ingredients that facilitate the forming process, the retention of the given shape or the shelf-life of formed products may be added at this further processing stage.

Flavor compounds, either produced by the inventive processes, or added during finishing, may be heat and oxygen sensitive, and may develop harsh or bitter qualities if over processed. Exemplary ingredients that may optionally be added at this stage, therefore, also include phenols and polyphenols, which may be employed, for example, as antioxidants/radical scavengers to limit the production of undesirable oxidized flavors during subsequent thermal processing (e.g., at elevated temperatures) or extended storage. By adding antioxidants at this stage, and subjecting the product compositions to only the heat needed for a safe food product, particular flavors (e.g., typical coffee-like bitterness or astringency) remain closer to the familiar coffee flavors.

Concentrating

The finished composition may be concentrated after formulation, and for such purposes see, e.g., the previous “Concentration” section for exemplary methods and details.

Instantizing

Individual components, for example flavorful liquid extracts or finished beverages, may be instantized by procedures such as those multi-step procedures known in the art. This may include the separation of volatile flavor components prior to drying, recovery of these compounds, and subsequent reintroduction prior to the drying process, as detailed below, resulting in the finished product. The process of volatile flavor collection may be accomplished by, for example, vacuum-assisted evaporative means, including the recovery of components using cryo traps. The deodorized liquid extract might be concentrated to a suitable total solid (TS, typically around 50%) by processes such as evaporation and freeze concentration, or the like. The concentrated liquid extract can then be combined with the volatile flavor fraction to be dried by processes such as spray drying, freeze drying, or the like. If desired, the previously separated flavor may then be added back to the residue (e.g., by coating, soaking, infusing, etc.). Instantizing may also be accomplished with or without separating volatile flavor components prior to drying, by using, for example, refractance window drying, and/or microwave assisted techniques, etc.

Forming/Pelletizing

Liquid, slurry, or powder materials may be formed, prior to packaging, into shapes, useful for or desired by the end-user, by processes such as agglomeration, granulation, extrusion, or the like. These include, but are not limited to, spheres, lozenges, coffee bean-like shapes, or other shapes that are easily ground, grated, shaved, or otherwise prepared for subsequent extraction to form a coffee beverage or incorporation into another food or beverage item (e.g., a powdered coffee topping).

Such formed items may then be further coated with other ingredients to improve their utility or usable shelf-life. These include, for example, anti-caking agents to prevent sticking, or barrier materials to limit the diffusion of aroma compounds out of the formed product and thus preserve the shelf-life of the flavor and aroma. Such coatings may be functional in the beverage as well as for the above purposes, for example a powdered colorant or flavor, a gum that hydrates when water is added.

Formed items may be subjected to thermal processing, as further detailed in the “Thermal Processing” section.

Packaging

Products may be filled into packaging appropriate to their format (such as, for example, cans, bottles, jars, bags, boxes, and the like) prior to, after or in the absence of thermal processing. Packaging can be single serve, multi-serve, bulk, industrial, or any other reasonable format.

The product entering the packaging need not be “complete” per se when it is added to the container. For example, liquid nitrogen can be added before sealing the pack to both produce an inert headspace or to produce nitrogen bubbles when the pack is opened. Other gases, or alternate phases of compounds that are gaseous at room temperature, e.g., dry ice, may be added (e.g., for purposes such as prolonging shelf-life/excluding oxygen).

Thermal Processing

Final thermal processing may be conducted to ensure product quality and/or safety. The specifics may depend on the format of the product. As discussed in the “Cross-reaction” section, such thermal processing methods generate flavors and can be used not only to make a safe, lasting product, but also to drive desired changes to produce a final composition in a pack.

Liquid products, such as RTD beverages, concentrates, liquid flavors, etc., may be subjected to one or more of a sterilization process (e.g. UHT, retort, microwave, ohmic), a pasteurization process (e.g. HTST), a homogenization process, or non-thermal antimicrobial treatments (e.g. HPP, irradiation) etc., chilling, freezing, and/or other methods not enumerated herein that are useful or sufficient to mitigate microbial risk (if required or desired). These methods may be, or include, in-container heat treatments. Alternatively, filling may occur after heat treatment.

Solid or powdered products, such as grounds, single use capsules, restructured or substitute “beans,” and the like, may likewise be heated before or after being placed in their packaging materials if necessary or desired to produce a particular composition. For compositions having a sufficiently low a_{W} (e.g., grounds or formed solids with pre-conditioned moisture levels), heating may not be necessary. However, as discussed previously, this final heating step may nonetheless be utilized to produce final flavors in a sealed container, which prevents their egress. Additionally, depending on the nature of ingredients added during formulation, thermal means may be used to remove solvents.

Augmented and/or Modified Coffee Substrates or Derivatives Thereof

As stated above, the inventive methods are not only applicable to non-coffee substrates, but also provide for improving the organoleptic qualities of a low-quality, flawed, or depleted (e.g., previously extracted or ‘spent’ grounds) coffee material. For example, coffee (e.g., a low quality or flawed coffee) may be used in the methods disclosed herein as the substrate carrier material having an endogenous Maillard-reactive nitrogen constituent and/or an endogenous Maillard-reactive carbohydrate constituent, and may be reacted with an exogenous Maillard reagent comprising an exogenous Maillard-reactive nitrogen constituent and/or and exogenous Maillard-reactive carbohydrate constituent to provide a conditioned coffee substrate carrier material, which may be, for example, dried, roasted, etc., to provide cross-Maillardized beverage components made from coffee.

In additional such aspects, traditional, low-quality, or depleted (e.g., previously extracted or ‘spent’ grounds) coffee material, or spent non-coffee material may be rejuvenated/regenerated/reformulated, for example, by addition of exogenous cross-Maillardized beverage components (e.g., concentrated extracts) made from coffee or from non-coffee substrate materials. Such regeneration/reformulation of spent coffee grounds, for example, may be performed as described above in relation to the above-described “Work-up” and “Finishing” steps, wherein e.g., exogenous cross-Maillardized concentrate extracts or flavors, etc. may be added to dried, traditional spent coffee grounds, or spent non-coffee materials, optionally along with other additives to provide for finished regenerated/reformulated coffee grounds, or finished non-coffee materials, which may then be extracted to provide for organoleptically satisfying beverage products. In preferred aspects, these regeneration/reformulation methods provide a solution for recycling traditional spent coffee grounds on a commercial scale.

In further methods, spent grounds from non-coffee substrate materials processed by the disclosed methods (cross-Maillardized or not), can likewise be regenerated/rejuvenated.

### Definitions

### Unless Otherwise Indicated:

“Maillard-reactive nitrogen constituent,” as used herein, refers to nitrogen constituents (e.g., of one or more of amino acids, peptides, oligopeptides, polypeptides, and/or proteins) that may react to form conjugates thereof with a Maillard-reactive carbohydrate constituent (e.g., sugars (mono-, di-, oligo- or polysaccharides), organic acids, and phenolic compounds;

“Maillard-reactive carbohydrate constituent,” as used herein, refers to carbohydrate constituents (e.g., mono-, di-, oligosaccharide, and/or polysaccharides) and/or derivatives thereof covalently bond to other constituents (e.g., organic acids, phenolic acids) that may react with a Maillard-reactive nitrogen constituents to form conjugates thereof (e.g., Amadori and/or Heyns compounds). Maillard-reactive carbohydrate constituents preferably comprise a reducing function (e.g., carbonyl group, reducing sugar), however, non-reducing sugars (e.g., saccharose) may also be converted to reducing components (e.g., glucose and fructose) by hydrolysis or heat treatment.

“Exogenous Maillard reagent,” as used herein, refers to an agent that is added or placed to be in contact with the substrate carrier material for purposes of forming one or more cross-Maillardization reaction products with Maillard-reactive moieties/groups that are endogenous to the substrate carrier material. In particular substrate-transactivation aspects, a substrate carrier material may be initially treated with one or more agents (e.g., enzymes, etc.) that may render (activate) or expose otherwise non-Maillard-reactive endogenous moieties/groups as Maillard-reactive endogenous moieties/groups (e.g., transactivation, by exposing and/or releasing them from the substrate material) and in such cases the trans-activated Maillard-reactive endogenous moieties/groups may cross-react with other endogenous Maillard-reactive groups, in which case such trans-activated Maillard-reactive moieties/groups may be considered as exogenous Maillard reagents.

“Conditioned substrate carrier material,” as used herein, refers to a substrate carrier material having an endogenous Maillard-reactive nitrogen constituent and/or an endogenous Maillard-reactive carbohydrate constituent, which substrate has been contacted with an exogenous Maillard reagent comprising an exogenous Maillard-reactive nitrogen constituent and/or and exogenous Maillard-reactive carbohydrate constituent under conditions sufficient to provide for cross-reaction products, preferably cross-Maillard reaction products, formable by the reaction between the exogenous Maillard reagent, and the endogenous Maillard-reactive constituent(s). Preferably, a conditioned substrate carrier material is one which is cross-reacted and/or cross-Maillard-reacted.

“Water activity (a_{w}),” as used herein, refers to the art-recognized meaning, e.g., the partial vapor pressure of water in a substance divided by the standard state partial vapor pressure of water. In the field of food science, the standard state is most often defined as the partial vapor pressure of pure water at the same temperature. Using this particular definition, pure distilled water has a water activity of exactly one.

“Cross-Maillardized substrate carrier material,” as used herein, refers to a substrate carrier material (e.g., having been at least conditioned as described herein) having cross-Maillard reaction products formed by the reaction between the exogenous Maillard reagent(s), and the endogenous Maillard-reactive constituent(s). These reactions take place more readily at elevated temperatures (e.g., >60° C.) and low water activity (e.g., <0.8) depending on the availability of the Maillard reactants. The cross-Maillardization products can be volatile or non-volatile, or even of polymeric nature. It is generally known that, at a given temperature, the MR rate increases with decreasing water activity.

“Natural plant material,” as used herein, includes but is not limited to those exemplary plant materials listed herein that come from plants, and may include restructured (e.g., fragmenting, grinding, milling, micronizing, depolymerizing (e.g., chemically, enzymatically, etc.), solubilizing, permeabilizing, compacting and/or compressing) plant material.

“High water activity cross-Maillard reaction products,” “high a_{w} cross-Maillard products,” or “HWACMP,” as used herein, refer to cross-Maillard reaction products formed with the substrate carrier material under preconditioning water activity (a_{w}) reaction conditions providing a conditioned (pre-conditioned) substrate carrier material as referred to herein. Operationally, high a_{w} at the conditioning reaction step is selected to be higher than that resulting from adjusting the water activity (a_{w}) of the conditioned substrate carrier material to a value less than that of the conditioning reaction. “Low water activity cross-Maillard products,” “low a_{w} cross-Maillard products,” or “LWACMPs),” as used herein, refer to cross-Maillard reaction products formed with the substrate carrier material, under conditions of a_{w} less than that of the conditioning (a.k.a.; pre-conditioning) reaction. Preferably, LWACMPs are those cross-Maillard reactions formed with the substrate under conditions of a_{w} less than or equal to, e.g., 0.85 (or, e.g., to less than or equal to another exemplary value as recited in clauses 12, 52 and 65) by reaction between an endogenous Maillard-reactive nitrogen constituent and/or an endogenous Maillard-reactive carbohydrate constituent, and an exogenous Maillard reagent comprising Maillard-reactive nitrogen and/or Maillard-reactive carbohydrate.

“Elevated temperature, low water activity cross-Maillard products,” “elevated temperature, low a_{w} cross-Maillard products,” or “ET-LWACMPs),” as used herein, refer to cross-Maillard reaction products formed with the substrate carrier material under conditions of temperature greater than that used for generating the LWACMPs.

### EXAMPLES

The following non-limiting examples are provided to further illustrate embodiments of the invention disclosed herein. It should be appreciated by those of skill in the art that the techniques disclosed in the examples that follow represent approaches that have been found to function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

TABLE 1
Summary of Examples

| | |
|---|---|
| Example | Subject matter |

Cross-Maillardization of non-coffee substrates

| | |
|---|---|
| 1 | Bean-less coffee-substitute beverage products were made from cross- |
| | Maillardized date seeds |
| 2 | A bean-less coffee-substitute beverage was made from a cross-Maillardized |
| | date seed extract |
| 3 | A bean-less coffee-substitute beverage was made from a cross-Maillardized |
| | Chicory root extract |
| 4 | A bean-less coffee-substitute beverage is made from a cross-Maillardized |
| | Yerba mate extract |
| 5 | A bean-less coffee-substitute beverage was made from a cross-Maillardized |
| | mustard seed extract |
| 6 | A bean-less coffee-substitute beverage is made from cross-Maillardized |
| | watermelon seeds, pumpkin seeds, Jerusalem artichoke, or roasted sesame |
| 7 | Exemplary composition prepared by combining portions (90%:5%:5%) of |
| | respective extracts prepared from cross-Maillardized date kernels, chicory |
| | root, and yerba mate |
| 8 | Sensory analysis was conducted on exemplary compositions; date kernels; |
| | Chicory Root and Buckwheat; Mustard Seed; Watermelon Seed; date |
| | kernels plus white mustard seeds |
| 9 | The cross-Maillardization reaction was shown, relative to controls, to |
| | differentially affect the levels of 2,5-Dimethylpyrazine (2,5-DMP) production |
| | in different stages of the disclosed methods; date kernels; Chicory Root and |
| | Buckwheat; Mustard Seed; Watermelon Seed; date kernels plus white |
| | mustard seeds |
| 10 | The cross-Maillardization reaction was shown, relative to controls, to |
| | differentially affect the levels of diacetyl production in different stages of the |
| | disclosed methods; date kernels; Chicory Root and Buckwheat; Mustard |
| | Seed; Watermelon Seed; date kernels plus white mustard seeds |
| 11 | The cross-Maillardization reaction was shown, relative to controls, to |
| | differentially affect the cellular structure of the conditioned substrate carrier |
| | material; date seeds |
| 12 | 1,3-bis[(5S)-5-amino-5-carboxypentyl]-4-methyl-1H-imidazol-3-ium |
| | (imidazolysine) production was shown, relative to controls, to be |
| | differentially regulated by the disclosed cross-Maillardization reaction; date |
| | seeds |
| 13 | A coffee-substitute beverage was made from cross-Maillardized cracked date |
| | seeds, and the optional use of added chlorogenic acid to the cross- |
| | Maillardization preconditioning mixture was shown to enhance the yield of |
| | γ-butyrolactone |
| 14 | A coffee-substitute beverage was made from cross-Maillardized fermented |
| | date seeds |

Rejuvenating non-coffee spent grounds, or other carriers

| | |
|---|---|
| 15 | Spent grounds of cross-Maillardized date seeds were reformulated using a |
| | cross-Maillardization product made by concentrating an extract of roasted, |
| | cross-Maillardized date seeds |
| 16 | A coffee-like beverage is made from regenerated spent (previously extracted) |
| | cross-Maillardized date seed grounds, using a cross-Maillardization |
| | approach |
| 17 | A coffee-like extract is made from spent (previously extracted) cross- |
| | Maillardized chicory root grounds, using a cross-Maillardization approach |
| 18 | A coffee-like roasted seed and grounds is made from reconstituted spent |
| | (previously extracted) cross-Maillardized date seeds or from pieces/chunks |
| | thereof, using a cross-Maillardization approach |
| 19 | A coffee-like roasted grounds is made from reconstituted spent (previously |
| | extracted) cross-Maillardized date seed grounds, and from co-roasted raw |
| | mustard seeds, using a cross-Maillardization approach |
| 20 | A coffee-like roasted grounds is made, using a cross-Maillardization |
| | approach, from reconstituted spent (previously extracted) cross-Maillardized |
| | date seed grounds and from the aroma distillate of separately roasted raw |
| | mustard seeds |
| 21 | A ground coffee-like product is made by rejuvenating spent cross- |
| | Maillardized date seed grounds using a cross-Maillard-derived rejuvenation |
| | product/material |
| 22 | A ground coffee-like product is made by reformulating spent cross- |
| | Maillardized date seed grounds using various formulation ingredients |
| 23 | A ground coffee-like product is made by combining cross-Maillardization- |
| | derived materials with a suitable carrier (e.g., sunflower seed shells) |

Cross-Maillardization of coffee substrates

| | |
|---|---|
| 24 | A cross-Maillardized coffee beverage was made from green coffee beans |
| 25 | A cross-Maillardized coffee beverage is made from green coffee bean chunks |
| 26 | A cross-Maillardized coffee beverage is made from steam-treated green |
| | coffee |
| 27 | A cross-Maillardized coffee beverage is made from robusta and arabica |
| | coffees |
| 28 | A cross-Maillardized coffee extract/flavoring is made from coffee |
| 29 | A roast & ground cross-Maillardized coffee is made from coffee and sesame |
| 30 | A cross-Maillardized coffee beverage is made from coffee and buckwheat |

Rejuvenating spent coffee grounds

| | |
|---|---|
| 31 | A coffee-like beverage was made from regenerated traditional spent |
| | (previously extracted) coffee grounds |
| 32 | A coffee-like beverage is made from regenerated traditional spent (previously |
| | extracted) coffee grounds |
| 33 | Spent coffee grounds were reformulated using a cross-Maillardization |
| | product made by concentrating an extract of roasted, cross-Maillardized date |
| | seeds |
| 34 | A ground coffee-like product is made by rejuvenating spent coffee grounds |
| | using liquid cross-Maillardization-derived products |
| 35 | A ground coffee-like product is made by rejuvenating spent coffee grounds |
| | using dried cross-Maillardization-derived products/materials |

### Example 1

### Bean-Less Coffee-Substitute Beverage Products were Made from Cross-Maillardized Date Seeds

This example describes making several products initially based on cross-Maillardized date kernels: a) cross-Maillardized date seed extract; b) formulated grounds from spent grounds; c) formulated spent grounds extract, d) formulated grounds from roasted grounds; and e) an extract from the formulated roasted grounds:

### a) Cross-Maillardized Date Seed Extract:

A bean-less, coffee-substitute beverage was made from a cross-Maillardized date seed extract, as follows:

In a first reaction, dry date kernels (e.g., 67 g Deglet Nour; cleaned of excess date flesh, stems and calyces) were added to an aqueous Maillard solution (containing 1% glycine (Ajinomoto), 1% arginine (Ajinomoto), 1% fructose (Tate and Lyle), and adjusted to pH 9.7 with KOH), and reacted for 3 hours at 85° C.;

Liquid and solids of the first reaction were separated via filtration, and the liquid discarded;

The solids were dried at or below 55° C. to <12% moisture (a_{w}<0.4, approx. 15 hrs), to provide a dried, conditioned substrate carrier material;

The dried kernels were roasted 4 minutes with predefined temperature profile to finished temp of 217° C., then cooled to provide roasted dried kernels (preferably, the date seeds are roasted to temperatures between 180-220° C.);

The cooled roasted date kernels were ground; milled fine (D10 ca. 200 μm, D50 ca. 500 μm, D90 ca. 800 μm), extracted (brewed) in 92° C. water for 4 minutes before gravity filtration to provide a liquid extract fraction (liquid coffee-substitute base extract fraction) and a retentate extracted grounds fraction (spent grounds fractions), followed by cooling of the liquid extract fraction to 4° C. for storage.

For final formulation, the date seed liquid coffee-substitute base extract was combined with caffeine, colorants, gums and flavors, filled into cans with nitrogen, and retorted, providing a beverage with notable coffee-like roasted flavors, as determined by sensory analysis (e.g., as in Example 8).

b) Formulated Grounds from the Spent Grounds Fraction of a):

The retentate grounds from the production of the coffee beverage in a) were dried by lyophilization. The resulting dry grounds were mixed with caffeine, flavors and colors in powder form and blended thoroughly.

### c) Formulated Spent Grounds Extract:

The resulting formulated grounds were then placed in the portafilter of an espresso machine, tamped with 100 N tamping force and extracted for 15 seconds at 93° C., 9 bar to provide an extract of the formulated spent grounds.

d) Formulated Grounds from Roasted Grounds:

Roasted, ground kernels, as described in a), are combined with caffeine, colors and flavors all in powder form, and mixed to provide formulated roasted grounds.

e) Extract from the Formulated Roasted Grounds of d):

The dry mix (formulated roasted grounds from d)) is blended well, then 20 g is placed into a paper filter cone supported above a mug. Hot water (95° C.) is poured slowly over the grounds until 180 g of total water have been added, and the extract collected, providing a beverage with notable coffee-like roasted flavors and aromas, as determined by sensory analysis (e.g., as in Example 8).

### Example 2

### A Bean-Less Coffee-Substitute Beverage was Made from a Cross-Maillardized Date Seed Extract

Raw, cleaned dried dates were combined with fructose, glycine, and aspartic acid at levels of 98.5%/0.5%/0.5%/0.5% in pH 8.5 water and incubated at 85° C. for 3 hours. The dates, separated from the liquid fraction, are then dried and roasted to a finished temperature of 218° C. The roasted seeds were then ground and extracted (95° C./4 minutes, 90% water, 10% kernels). By organoleptic comparison (as determined by sensory analysis as in Example 8), the extract prepared from date kernels that were processed in the same conditions but with no exogenous reagents, was cloudier, more astringent, and contained less roasted coffee-like character.

### Example 3

### A Bean-Less Coffee-Substitute Beverage was Made from a Cross-Maillardized Chicory Root Extract

Dried chicory root is crushed/ground to yield pieces <1 cm in diameter, then combined with a mixture of 1% lysine, 1% leucine, 1% phenylalanine, 0.1% cysteine, and 5% glucose (exogenous Maillard reagents). This mixture is blended with equal parts water to form a paste, which is then dried to a_{w}<0.6 at 75° C. The resulting cake is then roasted at 150° C. for 30-60 minutes, then ground and extracted (95° C./4 minutes). In organoleptic comparison (as determined by sensory analysis as in Example 8) to chicory root alone (processed without the exogenous Maillard reagents), the resulting cross-Maillardized beverage is darker, with a richer and more roasted aroma, including with notes of chocolate.

### Example 4

### A Bean-Less Coffee-Substitute Beverage is Made from a Cross-Maillardized Yerba Mate Extract

Yerba mate leaves and stems are soaked in an equal mass of a solution of 0.5% leucine, 0.5% lysine, and 2% glucose. The substrate is drained and dried to a_{w}<0.4 at 55° C., then toasted at 150° C. in an oven for 10 minutes. The toasted substrate is extracted in 70° C. water, then cooled to room temperature before washing with a neutral oil.

### Example 5

### A Bean-Less Coffee-Substitute Beverage was Made from a Cross-Maillardized Mustard Seed Extract

Defatted mustard seed powder (97.4%) was mixed with 1% glucose, 1% glycine, 0.5% chlorogenic acid and 0.1% sodium bicarbonate with just enough water to form a paste (roughly 20% of the dry ingredient mass), then dried below a_{w}<0.4. The dried mixture was then roasted to 200° C. over a 5 minute temperature ramp, cooled, extracted for 4 minutes using 95° C. water at a ratio of 90% water/10% seeds, and then filtered. In organoleptic comparison (as determined by sensory analysis as in Example 8) to a beverage prepared using roasted mustard seed powder alone, the resulting beverage contains more roasted and nutty coffee-like aroma with an increased bitterness and a decreased mustard aroma.

### Example 6

### (A Bean-Less Coffee-Substitute Beverage is Made from Cross-Maillardized Watermelon Seeds, Pumpkin Seeds, Jerusalem Artichoke, and/or Roasted Sesame

An extract (coffee-substitute beverage component) is prepared starting with a substrate comprising watermelon seeds, pumpkin seeds, Jerusalem artichoke, and/or roasted sesame. The plant material and respective extract, in each case, is prepared in accordance with the cross-Maillardization reaction methods, and other examples described herein.

### Example 7

### Exemplary Composition Prepared by Combining Portions (90%:5%:5%) of Respective Extracts Prepared from Cross-Maillardized Date Kernels, Chicory Root, and Yerba Mate

A mixed extract (coffee-substitute beverage component) is prepared by combining portions (90%:5%:5%) of respective extracts prepared from cross-Maillardized date kernels, chicory root, and yerba mate, each extract prepared in accordance with the cross-Maillardization reaction methods, and other examples described herein.

### Example 8

### Sensory Analysis was Conducted on Exemplary Compositions

The disclosed cross-Maillardization methods (employing substrate preconditioning reactions with exogenous Maillard reagents) and compositions provide important and crucial components normally found in coffee. The participants in the cross-Maillardization conditioning reactions may be: a substrate carrier material comprising or derived from an agricultural product; and exogenous Maillard reagents (e.g., carbohydrates and/or peptides, etc.) that react with the substrate constituents to create, directly and indirectly, the essential compounds for a coffee-substitute beverage. As described herein, these substrates and reagents may or may not be comprised of or derived from coffee. Additional important steps may comprise, inter alia, a moisture conditioning (or water activity modulating) step (e.g., drying, or alternatively moisturizing of the conditioned substrate carrier material), and/or subsequent a heating (e.g., roasting) step.

As described above in more detail at pages 14-15, exemplary desirable compounds of interest may be placed into 5 exemplary categories, which in each case can be further divided into subsets of related compounds that perform similar functions in the finished beverage.

In this example, several exemplary extract compositions were prepared in accordance with the disclosed cross-reaction (e.g., cross-Maillardization reaction) methods, to demonstrate the creation of some of these categories of aroma compounds:

Sample Preparation and Sensory Analysis

a) Date Kernel Extract Preparation:

Dried raw, cleaned date kernels are combined with fructose, glycine and aspartic acid at levels of 98.5%/0.5%/0.5%/0.5% in pH 8.5 water and processed at 85° C. for 3 hours. The conditioned date kernels are then dried to a_{w}<0.4 and roasted to a finished temperature of 218° C. The conditioned, dried, roasted kernels are ground, and extracted (95° C. for 4 minutes, 90% water, 10% kernels). In comparison to extract from date kernels processed in the same manner/conditions but with no exogenous reagents, the resulting sample prepared by the cross-Maillardization method is less cloudy and less astringent and contains a more roasted, coffee-like character.

b) Chicory Root and Buckwheat Extract Preparation

Small, dried chicory root pieces <1 cm in diameter (18.4% of the composition) were combined with raw buckwheat (73.5%) lysine (1%), leucine (1%), phenylalanine (1%), cysteine (0.1%) and glucose (5%). This mixture was blended with just enough water to form a paste (roughly 20% the mass of dry ingredients), which was then dried to a_{w}<0.3 at 75° C. The resulting cake was then roasted at 190° C. for 10 minutes, ground and extracted (95° C./4 minutes, 90% water, 10% grounds). In comparison to chicory root alone processed in the same manner/conditions but with no exogenous reagents, the resulting beverage prepared by the cross-Maillardization method was darker, with a richer and more roasted aroma with notes of chocolate.

c) Mustard Seed Extract Preparation

Defatted mustard seed powder (97.4%) was mixed with 1% glucose, 1% glycine, 0.5% chlorogenic acid and 0.1% sodium bicarbonate with just enough water to form a paste (roughly 20% of the dry ingredient mass), then dried below a_{w}<0.4. The dried mixture was then roasted to 200° C. over a 5 minute temperature ramp, cooled, and extracted for 4 minutes using 95° C. water at a ratio of 90% water/10% seeds and filtered. In comparison to a beverage prepared using roasted mustard seed powder alone, processed in the same manner/conditions but with no exogenous reagents, the resulting beverage prepared by the cross-Maillardization method contains more roasted and nutty, coffee-like aroma, and with an increased bitterness and a decreased mustard aroma.

d) Watermelon Seed Extract Preparation

Watermelon seeds were toasted at 160° C. for 10 minutes to reduce water activity to <0.2. The toasted seeds were ground and the derived powder (20%) was mixed with 8% glucose, 0.8% lysine, 0.8% proline and 0.1% cysteine, blended in water (70.3%) with pH adjusted to 8.5. The mixture was then heated at 75° C. for 24 hours. The thickened reaction mixture was spread out and dried to <0.2 a_{w}. The dried material was then roasted in an electric oven at 190° C. for 10 minutes, and after cooling, the roasted residue was extracted with water (95° C./4 min, 10% grounds, 90% water). The resulting beverage had a more sulfury, roasted-like aroma and darker color, compared to a beverage derived from watermelon seeds alone, processed in the same manner/conditions but with no exogenous reagents.

e) Mixed Substrate Extract Preparation

A mixed composition comprising raw, cleaned date kernels and white mustard seeds was combined with fructose, glycine and aspartic acid at levels of 93.5%/5%/0.5%/0.5%/0.5% in pH 9.7 water and processed at 85° C. for 3 hours. The mixture was then dried to a_{w}<0.3 and roasted to a finished temp of 200° C. The roasted seeds were ground, and extracted (95° C./4 minutes, 90% water, 10% kernels). In comparison to a mixture of date kernels and mustard seeds alone that were processed in the same conditions but with no exogenous reagents, the resulting sample is less astringent and contains a more caramel and sulfury, coffee-like aroma.

In addition to the above-described sensory/organoleptic evidence, the results described in the following chemistry working Examples 9-12 analyzing the above-described compositions, a)-e), provide additional strong evidence for the cross-reactions (e.g., cross-Maillardization) between substrate and exogenous reagents, in the conditioned, a_{w} adjusted (e.g., dried), heated (e.g., roasted), extracts and residual extracted material.

### Example 9

### The Cross-Maillardization Reaction was Shown, Relative to Controls, to Differentially Affect the Levels of 2,5-Dimethylpyrazine (2,5-DMP) Production in Different Stages of the Disclosed Methods

In this example, the disclosed cross-Maillardization methods (employing substrate preconditioning reactions with exogenous Maillard reagents) were shown, relative to controls, to differentially provide or enhance important components normally found in coffee.

Analytical Characterization—Gas Chromatography/Mass Spectrometry.

2,5-Dimethylpyrazine (2,5-DMP) is a volatile compound well known to contribute to roasted coffee flavor. Specifically, 2,5-DMP is known to contribute to the roasty and earthy flavors of coffee. It was selected for further quantification in the present methods as it is indicative specifically of the Maillard Reaction, and not of simple sugar breakdown (i.e., caramelization). Reactivity between an amino acid source and a carbohydrate source is required to produce this compound. Moreover, 2,5-DMP can be produced from nearly any combination of amino acid and carbohydrate, and thus the selection of amino acids and carbohydrates, as well as the substrate, may influence the rate of formation and the final concentration of 2,5-DMP. Accordingly, stages of the above-described methods leading to compositions a)-e) of Example 8, were analyzed, relative to controls, for the generation of 2,5-DMP, and the disclosed cross-Maillardization methods were shown, relative to controls, to differentially provide or enhance important components normally found in coffee. For data collection, each sample (crossMR, control, preconditioning solution and blank) was analyzed by means of Headspace SPME GC/MS (Agilent 5975 MSD, Agilent, Santa Clara, USA). The samples were worked up in a triplicate. For analysis, an aliquot of 5 mL of each sample was transferred into a headspace vial. The Vials were sealed and placed into a cooled (4° C.) autosampler (MSP, Gerstel, Muehlheim an der Ruhr, Germany). The samples were extracted using an SPME fiber (57298-U, 50/30 μm DVB/CAR/PDMS, Stableflex, 1 cm, Supelco, Bellefonte, USA) and transferred on the column in ‘splitless’ mode. The chromatography was carried out using a Stabilwax column (60 m, 0.32 mm ID, 1 μm df, RESTEK, Bellefonte, USA) and a temperature gradient, with an initial temperature of 35° C. and an increase of 7.5° C./min until a total of 250° C., holding the final temperature for 5 min. Helium was used as carrier gas. As detector, a single quad mass spectrometer was used. The compounds were ionized using EI in positive mode. The identification of the individual compounds was performed using the NIST-17 library. Data analysis was performed using python v3.7, MS Dial v.4.33 (Yokohama City, Japan) and Masshunter v11 (Agilent, Santa Clara, USA).

2,5-DMP was identified using an internal database and the NIST-11 database and was semi-quantified by normalizing the mass spectrometer intensities (in cps) of 2,5-DMP (mass to charge ratio, m/z, =109.07 [M+H]⁺) with the sample weights.

Extract composition a) (prepared from cross-Maillardized date kernels, as described in Example 8 above, was analyzed in comparison to controls to determine if cross reactivity between the substrate carrier material (date kernels) and exogenous Maillard reagents took place. The controls for these experiments comprised both kernels alone and the exogenous reagents alone, processed in otherwise identical fashion. More specifically, the kernels alone (“Control”) were preconditioned in pH 8.5 water at the same temperature and time, but lacked any exogenous reagents. The exogenous reagents alone (“MR”) were preconditioned in a pH 8.5 bath at the same temperature and time, but in the absence of kernels.

In each case, the sample workup was performed in duplicate. The samples were prepared identically and were each measured after the preconditioning step (heating in aqueous solution, pH 8.5, 3 hours), after drying (65° C./15 hours), after roasting (IKAWA Roaster, 210° C./7 min), after extraction (18 g/100 mL, immersion brew at 95° C./4 min) as well as the residue (extracted filtrate residue, dried at 65° C./4 hours).

Results. In general, it was found that cross-Maillardization reactions resulted in differential generation of low levels of 2,5-DMP in the preconditioning and drying steps (see FIG. 2). Cross reaction between exogenous reagents and substrate were observed, as evidenced by the differentially elevated levels of 2,5-DMP generated when substrate and reagents are reacted together, relative to controls. Furthermore, it was found that the level of 2,5-DMP generated during the thermal reaction step (“Roast”) was substantially greater in the sample containing both substrate and exogenous reagents (“CrossMR”), relative to the control samples combined. This is compelling evidence for a cross-Maillard reaction between these endogenous and exogenous groups, since the “CrossMR” level of 2,5-DMP far surpasses the value of the independent reaction of kernel components amongst themselves combined with that of the exogenous materials amongst themselves. Note for purpose of FIG. 2, the “MR” values were normalized by taking into account that approximately 11.25% (as determined by mass analysis) of the exogenous Maillard reagents were present (absorbed by the substrate) in the post-conditioned, separated and dried substrate material.

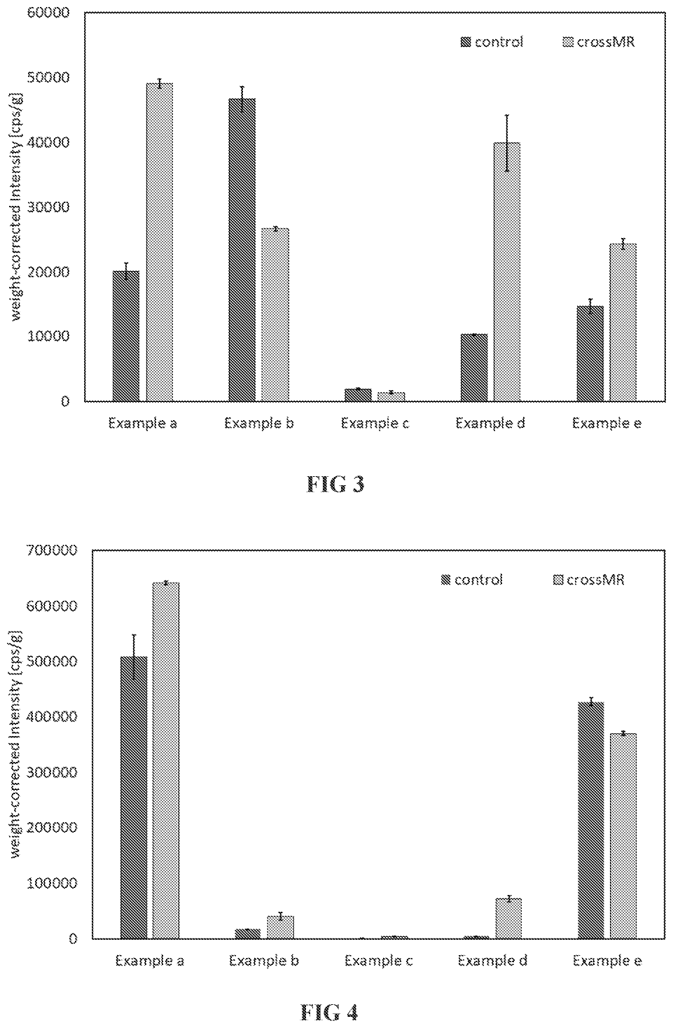

Similar experiments were conducted across all example compositions. The differentially increased 2,5-DMP yield was not universal across all examples (see FIG. 3, comparing the roasting stage values among the different substrates). Specifically, and surprisingly, while some combinations of reagents and substrates showed a differential increase in 2,5-DMP yield (i.e., as in examples a), d), and e), relating to date seed, watermelon seed, and mixed substrates, respectively), others showed a decrease in yield (as in b and c). According to particular aspects of the invention, therefore, selection of substrate and reagents may be used in the inventive methods to produce the desired type of products, such as volatile aroma compounds yielding roasted, fruity, etc. notes. As in FIG. 2, the normalized values for the “MR” samples (exogenous reagents alone) in these cases were negligible, and thus are not shown in FIG. 3). Careful selection of substrate and reagent, therefore, provides flexibility in producing desired final products, and surprisingly, combination of some substrates and exogenous Maillard reagents can result in a decreased yield of one or more particular, potentially desired compounds.

### Example 10

### The Cross-Maillardization Reaction was Shown, Relative to Controls, to Differentially Affect the Levels of Diacetyl Production in Different Stages of the Disclosed Methods

In this example, relating to compositions a)-e) of Example 8, the disclosed cross-Maillardization methods (employing substrate preconditioning reactions with exogenous Maillard reagents) were shown, relative to controls, to differentially provide or enhance important components normally found in coffee.

According to additional aspects of the present invention, reactions can occur in the disclosed cross-reactions systems wherein reactants of substrate and exogenous systems interact, but do not ultimately result in compounds formed directly therefrom (i.e., do not result in direct cross-reaction product molecules). For example, the presence of both the substrate and the exogenous reagents may, indirectly (e.g., by affecting the reaction pathway leading to a desirable compound), enhance the generation of desirable compounds even if that desirable compound is not the direct, or even indirect, reaction product of a reaction between endogenous and exogenous reagents.

For example, 2,3-butanedione is an art-recognized marker for caramelization reactions as well as the Maillard reactions, and its formation involves mainly carbon atoms of the carbohydrate source. 2,3-Butanedione was identified using an internal database and the NIST-11 database and was semi-quantified by correcting the mass spectrometer intensities (in cps) of 2,3-butanedione (m/z=87.09 [M+H]⁺) with the sample weights (in g). For data collection, each sample (crossMR, control, preconditioning solution and blank) was analyzed by means of Headspace SPME GC/MS (Agilent 5975 MSD, Agilent, Santa Clara, USA). The samples were worked up in triplicate. For analysis, an aliquot of 5 mL of each sample was transferred into a headspace vial. The Vials were sealed and placed into a cooled (4° C.) autosampler (MSP, Gerstel, Muehlheim an der Ruhr, Germany). The samples were extracted using an SPME fiber (57298-U, 50/30 μm DVB/CAR/PDMS, Stableflex, 1 cm, Supelco, Bellefonte, USA) and transferred on the column in ‘splitless’ mode. The chromatography was carried out using a Stabilwax column (60 m, 0.32 mm ID, 1 μm, RESTEK, Bellefonte, USA) and a temperature gradient, with an initial temperature of 35° C. and an increase of 7.5° C./min until a total of 250° C., holding the final temperature for 5 min. Helium was used as carrier gas. A single quad mass spectrometer was used for detection. The compounds were ionized using EI in positive mode. The identification of the individual compounds was performed using the NIST-17 library. Data analysis was performed using python v3.7, MS Dial v.4.33 (Yokohama City, Japan) and Masshunter v11 (Agilent, Santa Clara, USA).

As demonstrated in FIG. 4, the presence of exogenous amino acids and substrate/carrier material impact the formation rate and reaction kinetics of 2,3-butanedione in the CrossMR samples, whether they are explicitly part of the reaction pathway (Maillard) or not (caramelization). As in FIGS. 2 and 3, the normalized values for the “MR” samples (exogenous reagents alone) in these cases were negligible, and thus are not shown in FIG. 4).

As demonstrated in FIG. 4, the presence of exogenous amino acids and substrate/carrier material impact the formation rate and reaction kinetics of 2,3-butanedione in the CrossMR samples, whether they are explicitly part of the reaction pathway (Maillard) or not (caramelization). As in FIGS. 2 and 3, the normalized values for the “MR” samples (exogenous reagents alone) in these cases were negligible, and thus are not shown in FIG. 4)..

According to particular aspects, therefore, flavorful aroma compounds are differentially produced resulting from the interaction of exogenous and substrate materials using the inventive methods.

### Example 11

### (The Cross-Maillardization Reaction was Shown, Relative to Controls, to Differentially Affect the Cellular Structure of the Conditioned Substrate Carrier Material

In this example, the disclosed cross-Maillardization methods (employing substrate preconditioning reactions with exogenous Maillard reagents) were shown, relative to controls, to differentially affect the cellular structure of the conditioned substrate carrier material.

Following the procedure for generating the extract composition of example a) of above Example 8 (date kernels), a crossMR sample (date kernels conditioned with exogenous reagents) and a control (date kernels alone) were prepared. Both the conditioned samples and the control were drained and then dried at 65° C. for 15 hours. Dried samples were fractured to expose the inner structures, and the fractured samples analyzed by means of scanning electron microscopy (SEM) using an FEI Quanta FEG-SEM at 2 kV accelerating voltage.

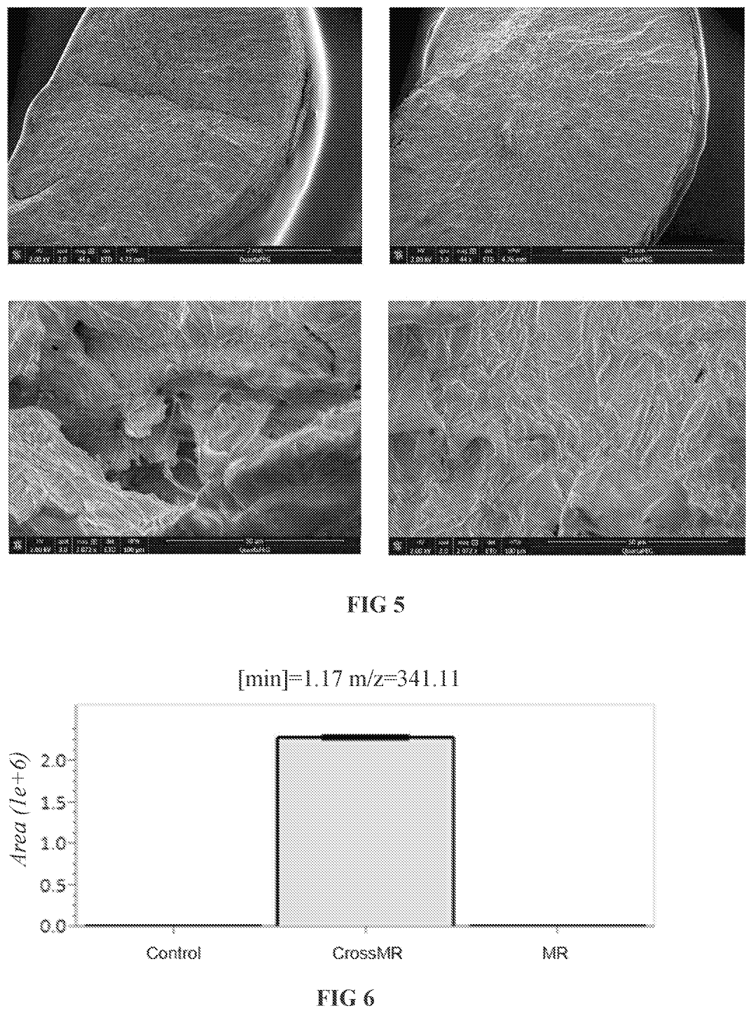

The differences between control and combined samples are readily observable using such imaging conditions (see FIGS. 5A-D). Kernels preconditioned without exogenous reagents show an open, porous structure (panels A, C), whereas kernels preconditioned with the exogenous reagents show a relatively denser, fuller structure (panels B and D). The images in FIG. 5 show changes in the cellular structure mediated by the cross-Maillard reaction, wherein the Control (panels A, C) samples show a highly porous structure, whereas CrossMR (B and D) samples exhibit a more dense and fuller cellular structure. This suggests the entry of the reagents into the kernel tissues, consistent with cross-reactivity, particularly given the short lifetimes of some Mallard intermediates. If the exogenous reagents only existed on the outer surface(s) of the substrate, cross reactions would be significantly limited and independent reactions of exogenous reagents and substrate tissues would more likely predominate. As evidenced by the above-described 2,5-DMP data, however, significant cross-Maillardization reaction products are produced by this combination.

### Example 12

### (1,3-bis[(5S)-5-amino-5-carboxypentyl]-4-methyl-1H-imidazol-3-ium (Imidazolysine) Production was Shown, Relative to Controls, to be Differentially Regulated by the Disclosed Cross-Maillardization Reaction

In this example, the disclosed cross-Maillardization methods (employing substrate preconditioning reactions with exogenous Maillard reagents) were shown, relative to controls, to differentially regulate production of 1,3-bis[(5S)-5-amino-5-carboxypentyl]-4-methyl-1H-imidazol-3-ium (imidazolysine).

Liquid Chromatography/Mass Spectrometry

The liquid extract composition of example a) (prepared from date kernels) of above Example 8, was analyzed in comparison to controls to look for cross reactivity. The kernels alone (“Control”) were preconditioned in pH 8.5 water at the same temperature and time, but lacked any exogenous reagents. The exogenous reagents alone (“MR”) were preconditioned in a pH 8.5 bath at the same temperature and time, but in the presence of no kernels.

The sample workup was performed in duplicate. The samples were prepared identically and were each measured after the preconditioning step (heating in aqueous solution, pH 8.5, 3 hours), after drying (65° C./15 hours), roasting (IKAWA Roaster, 210° C./7 min) and extraction (18 g/100 mL, immersion brew at 95° C./4 min followed by gravity filtration).

The individually prepared extract samples were then prepared for analysis by diluting each sample to a concentration of 1 mg/mL, followed by membrane filtration. The analysis was performed by means of a high-resolution ultra-performance liquid chromatography system, coupled to an ion mobility time of flight mass spectrometer for detection, and 2 μL of each sample (biological duplicate (two separate workups), five injections each, technical quintuplicate) were injected for analysis. The measurement was performed in electrospray ionization (ESI) in both, positive and negative mode. The data was then evaluated by statistical tools, such as principal component analysis (PCA) and partial least square analysis (PLSA). More specifically, for data collection each sample (crossMR, control, preconditioning solution and blank) was analyzed by means of UPLC-ToF/MS (Agilent 6500 Q-ToF, Agilent, Santa

Clara, USA). Each of the samples was worked up in duplicate and injected five times for profiling analysis. An aliquot of 5 mL of each sample was diluted 1:1000 (v/v, sample/Millipore water), filtered (Minisart Syringe Filter, pore size 0.22 μm, Sartorius, Goettingen, Germany) and transferred into LC vials. The vials were placed into the autosampler of the device and an aliquot of 2 μL was injected. The chromatography was carried out using an RP-18 column (Kinetex 1.7 μm C18 100 Å, 100×2.1 mm, Phenomenex, Aschaffenburg, Germany) as the stationary phase. The stationary phase was preheated at 50° C. As the mobile phase, water (A, 0.1% FA, Millipore-Q) and acetonitrile (B, 0.1% FA, HPLC grade) was used at a flow rate of 0.3 mL/min. The starting conditions were 100% A. After 1 min, B was increased gradually for 4 min to 100% and kept at 100% B for 30 sec. Eluted chromotography samples were ionized using electro spray ionization, and run separately in positive and negative mode. The compounds were identified using their accurate mass, and by their elemental composition, as well as in comparison with internal libraries of reference compounds. Data analysis was performed using python v.3.7, MS Dial v.4.33 (Yokohama City, Japan) and Masshunter v11 (Agilent, Santa Clara, USA).

A compound detectable using these techniques is 1,3-bis[(5S)-5-amino-5-carboxypentyl]-4-methyl-1H-imidazol-3-ium; exact mass 341.10999 m/z from negative ESI). The compound might be expected via the breakdown of both exogenous fructose as well as the endogenous glucose (e.g., in date kernels) to methylglyoxal, and its reaction with lysine (from the substrate) to form the dimer. Imidazolysine is a product of prolonged Maillard reaction, and, as known in the case of coffee, primarily contributes its deep yellow-brown color to the roasted beans and beverage.

FIG. 6 shows, for the liquid extract stages of the samples a) (date kernels) of Example 8, the semi-quantitation of imidazolysine in the “Control,” “CrossMR” and “MR” extract samples. Imidazolysine is only formed in the “CrossMR” samples (2.2×10⁶ cps/g), whereas the compound was not found in detectable amounts in the “Control” and the “MR” sample (FIG. 6). This compound is present in conventional coffee, however the yield is relatively lower than in the exemplified extract composition. For example, the level of imidazolysine in a conventional coffee beverage is shown at the far right.

According to particular aspects of the present invention, therefore, at least for particular substrate materials, imidazolysine is exclusively formed by the inventive crossMR approach, which provides for production of compounds not attainable by processing of substrates alone, or of exogenous reagents alone. Moreover, the disclosed crossMR approach provides a method of controlling the production level of such compounds (e.g., by varying the concentration/amount of exogenous reagents, exposure time to same, exposure temperature to same, etc.).

### Example 13

### A Coffee-Substitute Beverage was Made from Cross-Maillardized Cracked Date Seeds, and the Optional Use of Added Chlorogenic Acid to the Cross-Maillardization Preconditioning Mixture was Shown to Enhance the Yield of γ-Butyrolactone

Cracked date seeds. Prior to the CrossMR process, dry, intact date seeds were cracked into pieces between 2 and 6 mm in diameter. These pieces were then preconditioned (optionally with Eucommia bark extract as a source of chlorogenic acid), roasted, extracted (as in Example 8, composition a)) and analyzed (using SPME-GC/MS) using the same protocol as described in Example 9.

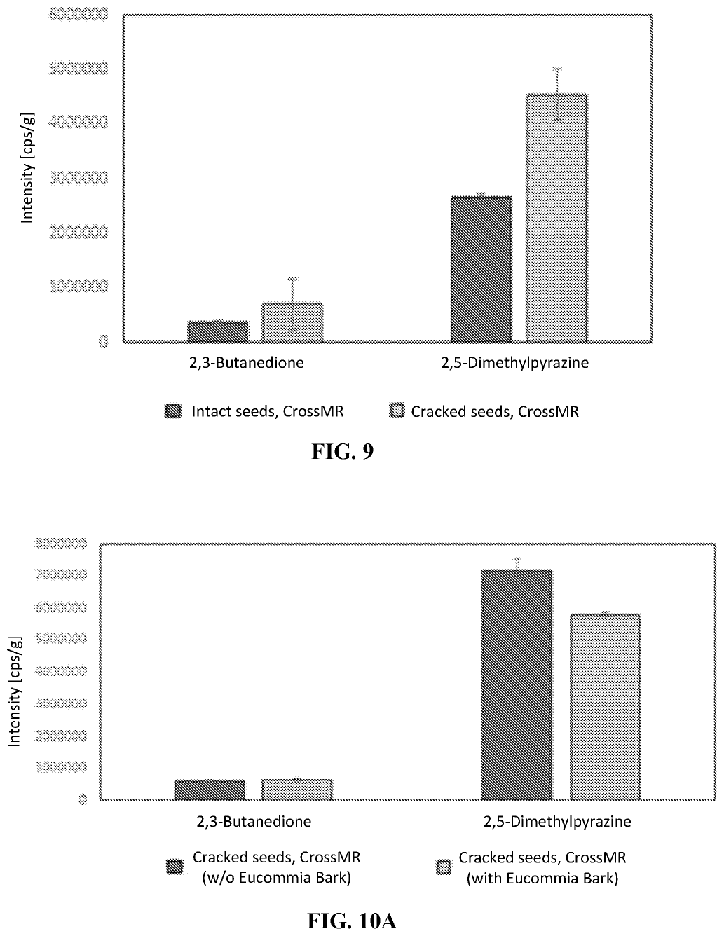

The resulting levels of 2,3-butanedione and 2,5-methylpyrazine are summarized in FIG. 9, showing that initial cracking of the date seeds prior to preconditioning enhances the yield of cross-Mailladization products.

While 2,3-butanedione is a product of multiple chemical pathways, 2,5-dimethylpyrazine is exclusively produced in these systems from a Maillard process. Thus the dramatic enhancement of 2,5-dimethylpyrazine production can be attributed to a significantly greater degree of cross-Maillard reaction taking place when the seeds are initially cracked in the process.

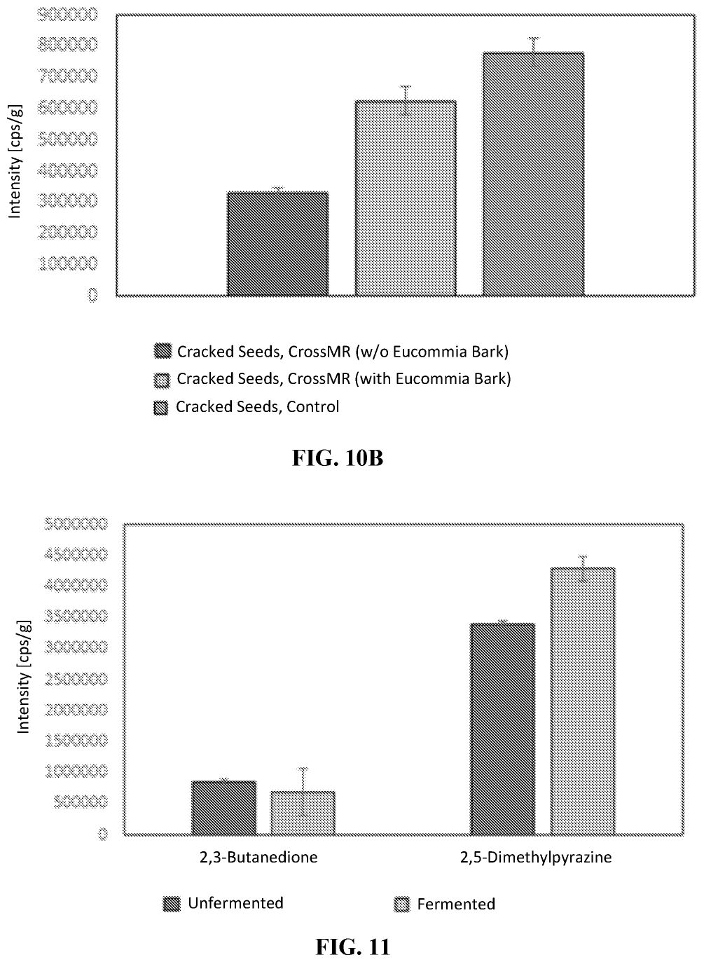

Cracked Date Seeds with the addition of Eucommia Bark extract. Prior to the CrossMR process, dry, intact date seeds were cracked into pieces between 2 and 6 mm in diameter. Half of the pieces were preconditioned by first immersing the seed pieces in a solution of 1% fructose, 1% lysine, 0.5% leucine, 0.5% glycine (2:1 w/w ratio solution:cracked seeds). The other half of the pieces were placed in an identical solution, but with the addition of 2.5% chlorogenic acid (sourced from Eucommia ulmoides). Both samples were brought to pH 8.5 and then heated to 55° C. and stirred at that temp for 2 hours. After 2 hours, materials were drained and dried for 15 hours at 55° C. Both samples were then roasted, extracted and analyzed (using SPME-GC/MS) using the same protocol as described in Example 9. The resulting levels of 2,3-butanedione and 2,5-dimethylpyrazine are summarized in FIG. 10A, showing that addition of chlorogenic acid to the preconditioning reaction modulates (in this instance decreases) the level of 2,5-dimethylpyrazine generated. FIG. 10B shows that while cross-Maillardization lowers the level of γ-butyrolactone relative to non-cross-Maillardized cracked date seeds (control cracked date seeds), addition of chlorogenic acid to the cross-Maillardization preconditioning mixture enhances the yield of γ-butyrolactone in cross-Maillardized date seeds

### Example 14

### A Coffee-Substitute Beverage was Made from Cross-Maillardized Fermented Date Seeds

Prior to the CrossMR process, date seeds with approximately 10% residual fruit were immersed in twice their combined mass in water and brought to 38° C. This mixture was covered and allowed to ferment naturally for 48 hours, during which time the fruit was partially digested. After draining and rinsing the remaining fruit, the fermented seeds were dried to a_{w}<0.6 and preconditioned (optionally with Eucommia bark extract), roasted, extracted and analyzed (using SPME-GC/MS) using the same protocol as described in Example 9. The resulting levels of 2,3-butanedione and 2,5-methylpyrazine are summarized in FIG. 11, showing that fermenting the date seeds prior to preconditioning enhances the yield of cross-Maillardization products.

As stated above in relation to Example 13, 2,3-butanedione is a product of multiple chemical pathways, whereas 2,5-dimethylpyrazine is exclusively produced in these systems from a Maillard process. Thus the enhancement of 2,5-dimethylpyrazine production can be attributed to a significantly greater degree of cross-Maillardization taking place after subjecting the seeds to a fermentation process.

### Example 15

### Spent Grounds of Cross-Maillardized Date Seeds were Reformulated Using a Cross-Maillardization Product Made by Concentrating an Extract of Roasted, Cross-Maillardized Date Seeds

Spent (previously extracted) grounds of Cross-Maillardized date seeds were dried to a_{w}<0.4, and 25 g of these dried grounds were initially combined with 5 g of a dry cross-Maillardization product made by concentrating an extract of roasted, cross-Maillardized date seeds to >99% solids using a refractance window drying system. This mixture was then combined with 0.5 g of soluble fiber, 0.2 g of a dry flavor, 0.14 g of a dry, soluble color, 0.15 g of caffeine and 0.25 g of roasted, ground chicory root. This combined mixture was then extracted using a drip machine to create a hot beverage with notable coffee-like roasted, caramelized flavors, as determined by sensory analysis (e.g., as in Example 8).

### Example 16

### (A Coffee-Like Beverage is Made from Regenerated Spent (Previously Extracted) Cross-Maillardized Date Seed Grounds, Using a Cross-Maillardization Approach

Previously extracted cross-Maillardized date seed grounds are prepared (dried) by adjusting the a_{w}<0.60 at 55° C. for 16 h. The dried spent grounds are combined with an aqueous solution (1:2, wt/wt grounds:solution) containing 2.5% polyhydroxylated phenolic compounds (e.g., as derived from Eucommia bark rich in chlorogenic acid), 5% wt/wt molasses, 2.5% wt/wt pea protein hydrolysate, 1% wt/wt lysine, 1% wt/wt leucine and 0.25% wt/wt cysteine. The mixture is stirred at 60° C. for 6 h, the supernatant discharged, and the a_{w} of the preconditioned spent date grounds is adjusted to <0.4 by heating the spent grounds at 140° C. for 1.5 h, to provide for cross-Maillardization. A coffee-like beverage is prepared by extracting the cross-Maillardized, reconstituted spent date grounds with hot water (e.g., at 92° C.) over a filter. The extract is confirmed by sensory analysis (e.g., using methods as described above in Example 8) to have a distinct coffee-like, and pleasant caramel-like aroma, with a low bitterness. The extract may be combined with one or more of caffeine, gums and/or flavors. A final formulation may be concentrated using, for example, reverse osmosis or microwave-assisted evaporation techniques, to derive a thick, paste-like coffee-base that can be reconstituted with water to prepare a coffee beverage.

### Example 17

### (A Coffee-Like Extract is Made from Spent (Previously Extracted) Cross-Maillardized Chicory Root Grounds, Using a Cross-Maillardization Approach

Previously extracted cross-Maillardized chicory root (e.g., grounds) are treated with hydrolytic enzymes (e.g., cellulase and trypsin), to release mono/di- and oligosaccharides. The a_{w} of the enzymatic-treated spent grounds is adjusted to <0.6 at 55° C./16 h, before being extracted with hot water (e.g., 92° C.) multiple times, using elevated pressure (e.g., 9 bars). The extracts are collected, pooled and combined with an aqueous solution (1:1, wt/wt pooled extract:solution) containing 2.5% polyhydroxylated phenolic compounds (e.g., as derived from Eucommia bark rich in chlorogenic acid), 5% wt/wt molasses, 2.5% wt/wt pea protein hydrolysate, 1% wt/wt lysine, 1% wt/wt leucine, 0.25% wt/wt cysteine, and 2% caffeine. The mixture is stirred at 60° C. for 6 h, and the a_{w} of the preconditioned spent chicory ground extract is adjusted to <0.2 by drying the mixture using a microwave-assisted evaporation system. The resulting cross-Maillardized concentrate can be used to reconstitute a coffee-like beverage by adding water, where the reconstituted beverage is confirmed by sensory analysis (e.g., using methods as described above in Example 8) to have distinct coffee-like, pleasant caramel and roasted aromas, with a mild astringent bitterness.

### Example 18

### A Coffee-Like Roasted Seed and Grounds is Made from Reconstituted Spent (Previously Extracted) Cross-Maillardized Date Seeds or from Pieces/Chunks Thereof Using a Cross-Maillardization Approach

Previously extracted cross-Maillardized spent date seeds (e.g., seeds or pieces thereof) are treated in an aqueous environment with hydrolytic enzymes (e.g., cellulase) to expose and/or release saccharides and amino acids from the date material. The treated date material solution is then heated to 80° C./10 min to deactivate the enzymes, and eucommia bark extract, caffeine, malt extract and yeast extract are added to 2.5%, 1%, 5% and 1.5% wt/wt, respectively. The mixture is dried by adjusting it to a_{w}<0.6 at 55° C./24 h, and then heated to 140° C. for 20 mins (e.g., ramp to 140° C., or continuous at 140° C. for 20 mins) in an electric oven, to provide for cross-Maillardization. The derived, reconstituted cross-Maillardized spent date grounds can be then used to prepare coffee-like beverages.

### Example 19

### A Coffee-Like Roasted Grounds is Made from Reconstituted Spent (Previously Extracted) Cross-Maillardized Date Seed Grounds, and from Co-Roasted Raw Mustard Seeds, Using a Cross-Maillardization Approach

Previously extracted cross-Maillardized date seed grounds (spent date seed grounds) are dried to a_{w}<0.6 at 55° C. for 16 h. Mustard seeds (5% wt/wt), eucommia bark extract (rich in chlorogenic acids) (2% wt/wt), molasses (5% wt/wt), and lysine, leucine, and glycine (each at 1% wt/wt) is added to the dried spent grounds. After homogenization, water is added (1:2, w/w homogenate:water) and the pH adjusted to pH=8.5. The mixture is then stirred at 55° C. for 2 hours, before excess water is removed by adjusting the mixture to a a_{w}<0.6 at 55° C. for 16 h. The dried mixture is then heated in an electric oven at 140° C. for 30 minutes (to provide for cross-Maillardization), immediately cooled down, and homogenized in a grinder. The derived powder is confirmed by sensory analysis (e.g., using methods as described above in Example 8) to have a similar color and flavor profile compared to conventional roasted and ground coffee. The powder can be packed in bags under inert conditions or packed in capsules or comparable single-/multi-serve containers.

### Example 20

### A Coffee-Like Roasted Grounds is Made, Using a Cross-Maillardization Approach, from Reconstituted Spent (Previously Extracted) Cross-Maillardized Date Seed Grounds and from the Aroma Distillate of Separately Roasted Raw Mustard Seeds

Previously extracted cross-Maillardized date seed grounds (spent date seed grounds) are dried to a_{w}<0.6 at 55° C. for 16 h. To the dried spent grounds, eucommia bark extract (rich in chlorogenic acids) (2% wt/wt), molasses (5% wt/wt), and lysine, leucine and glycine (each at 1% wt/wt) is added. After homogenization, water is added (1:2, w/w homogenate:water) and the pH adjusted to pH=8.5. The pH-adjusted mixture is then stirred at 55° C. for 2 hours, before excess water is removed by adjusting the mixture to a a_{w}<0.6 at 55° C. by drying for 16 h. The dried mixture is then heated in an electric oven at 140° C. for 30 minutes, to provide for cross-Maillardization.

Mustard seeds are roasted to a final temperature of 220° C. and immediately cooled down. The roasted mustard seeds are ground and the aroma fraction is distilled (e.g., by using a distillation apparatus, and a cold-trap containing nonpolar solvent as trapping solvent) and collected in a cooled aroma trap. The aroma distillate is then combined with the previously roasted, cross-Maillardized reconstituted spent date seed grounds. The aromatized cross-Maillardized spent grounds are filled into single-serve capsules, which are packed and sealed under inert gas.

Individual capsules are applied/processed on a coffee capsule system to prepare an espresso beverage. The resulting coffee-like beverage is confirmed by sensory analysis (e.g., using methods as described above in Example 8) to have intense, fresh roasted aromas, compared to spent date seed grounds, mimicking the aroma profile of conventional coffee capsules.

### Example 21

### A Ground Coffee-Like Product is Made by Rejuvenating Spent Cross-Maillardized Date Seed Grounds Using a Cross-Maillard-Derived Rejuvenation Product/Material

The spent date seed grounds retained from a cross-Maillardized date seed extraction are dried to a_{w}<0.6. These dried grounds are sieved to remove particles <100 μm and >400 μm in size, then combined (e.g., mixed, combined, coated, etc.) with a dry, cross-Maillardized rejuvenation preparation/material, derived originally from a cross-Maillardized material (e.g., prepared as described herein, from one or more of date seeds, chicory root, yerba mate, mustard seed, etc., as in example 35). The grounds may be further reformulated by addition of one or more dry flavorings, caffeine, soluble colors and/or texture modifying ingredients such as gums, etc.

The dried rejuvenated, optionally reformulated spent date seed grounds may be extracted (brewed) to provide a reformulated spent date seed grounds extract fraction, confirmed by sensory analysis (e.g., using methods as described above in Example 8) to have particular roasted coffee-like characters reflecting the particular cross-Maillardized rejuvenation material(s) used.

### Example 22

### A Ground Coffee-Like Product is Made by Reformulating Spent Cross-Maillardized Date Seed Grounds Using Various Formulation Ingredients

The spent date seed grounds retained from a Cross-Maillardized date seed extraction are dried to a_{w}<0.6. These dried grounds, optionally sized selected as in example 30, are then reformulated by combining (e.g., mixed, combined, coated, infused, soaked, etc.) with one or more of: flavorings (e.g., dry powder or liquid), caffeine, soluble colors and/or texture modifying ingredients (e.g., gums, etc.), etc.

The dried reformulated, optionally reformulated spent date seed grounds may be extracted (brewed) to provide a reformulated spent date seed grounds extract fraction, confirmed by sensory analysis (e.g., using methods as described above in Example 8) to have particular roasted coffee-like characters reflecting the particular reformulation ingredients.

### Example 23

### A Ground Coffee-Like Product is Made by Combining Cross-Maillardization-Derived Materials with a Suitable Carrier (E.g., Sunflower Seed Shells)

Carrier grounds are produced by milling toasted (e.g., dark brown color) sunflower seed shells to a particle size suitable for various respective coffee machines (ex: drip, espresso, etc.). These grounds are then soaked in a liquid cross-Maillardization-derived concentrate (e.g., prepared as described herein, from one or more of date seeds, chicory root, yerba mate, mustard seed, etc., as in example 35) for 2 hours at room temperature, then dried to a_{w}<0.6. The grounds may be further reformulated by addition of one or more of: dry flavorings, caffeine, soluble colors, and/or texture modifying ingredients such as gums, etc.

### Example 24

### A Cross-Maillardized Coffee Beverage was Made from Green Coffee Beans

Whole raw (green) coffee beans were washed in hot water (80° C.) for 1 hour. Afterwards, the aqueous extraction media was discarded and the green coffee beans dried by lyophilization. An aqueous solution containing 5% malt extract (carbohydrate source) and 5% pea protein hydrolysate (amino acid source) was added to the washed green coffee (1:5, w/w, coffee:solution), and the mixture placed under a vacuum (<20 mbar) for 20 minutes at room temperature (to enhance infusion into beans). The liquid was drained and the surface of the infused beans rinsed briefly with water. These coffee beans, infused with the exogenous precursor solution, were then adjusted to a_{w}<0.6 by dehydrating at 55° C. The dried, preconditioned coffee was roasted for 6.5 min to a final temperature of 210° C., and the roasted, cross-Maillarized coffee then ground, and a beverage prepared by cold immersion brew (4° C. for 16 hours). The resulting beverage was determined by sensory analysis to be more flavorful and showed improved coffee qualities—in particular it showed higher degrees of roasted, nutty, and burnt aroma qualities—in comparison to results obtained by identical processing of green coffee beans but without infusion with the exogenous precursor solution.

The samples (and appropriate controls) were further analyzed by Headspace-SPME-GC/MS using methods analogous to those used in Example 9. The results are summarized in FIG. 7, were “crossMR” is cross-Maillardized green coffee bean material, “MR” is the similarly processed exogenous Maillard reagents alone, and “Control” is green coffee beans (similarly processed but without exogenous Maillard reagents).

These data show the production of 2,3-butanedione was enhanced by over 25% by use of these compositions and methods. Simultaneously, the levels of 2,5-dimethylpyrazine are reduced by nearly 50%. These results highlight the utility of the inventive cross-Maillardization methods to shift/tailor the flavor profile of green coffee to a preferred endpoint—in this case, enhancement of buttery flavors and a reduction of earthy, roasted flavors.

### Example 25

### A Cross-Maillardized Coffee Beverage is Made from Green Coffee Bean Chunks

Raw (green) coffee chunks (e.g., broken raw coffee) is infused with warm water for (55° C.) for 8 h, the supernatant discharged, and the infused raw coffee lyophilized. An aqueous solution containing amino acids (1% lysine, 1% glycine, 1% leucine) and a reducing sugar (5% xylose), is added to the freeze-dried raw coffee chunks (2:1, w/w, solution:coffee) and stirred for 4 h at room temperature. The surfaces of the chunks are briefly rinsed with water and the infused, rinsed chunks adjusted to a a_{w}<0.75, by dehydrating at 55° C. The dried, preconditioned coffee chunks are roasted to a final temperature of 205° C. for 6 minutes to provide roasted, cross-Maillardized coffee chunks, which are then ground and filled into capsules (e.g., single-serve capsules, such as K-cup, Nespresso, etc.). The capsules are then placed in a suitable machine (e.g., Nespresso “Essenza Mini”) and a coffee beverage (e.g., 110 mL) is prepared. The resulting beverage is confirmed by sensory analysis (e.g., using methods as described above in Example 8) to have an improved aroma profile in comparison to non-cross-Maillardized coffee chunks (e.g., with increased intensities of caramel, chocolate, and roasted aromas.

### Example 26

### A Cross-Maillardized Coffee Beverage is Made from Steam-Treated Green Coffee

Raw (green) coffee (e.g., beans and/or chunks) (e.g., low quality green coffee beans and/or chunks) is treated with hot steam (160° C./14 minutes). The steam is condensed to provide a coffee-enriched wastewater, non-volatile compounds (e.g., chlorogenic acids and saccharides) are extracted into the wastewater from the steam-treated coffee, and the extract purified using solid-phase assisted extraction. The steam-treated coffee is then combined with an aqueous solution (1:2, w/w coffee:solution), containing 2% of the purified coffee-enriched wastewater extract (containing chlorogenic acids and other polyhydroxylated phenolic compounds) and 1.5% zein hydrolysates, the mixture stirred for 4 h at room temperature, and the infused coffee rinsed with water before being adjusted to a_{w}<0.75 by dehydrating at 55° C. The preconditioned, coffee-enriched coffee beans and/or chunks are roasted to a final temperature of 210° C. The roasted, cross-Maillardized enriched coffee is then ground, and a hot beverage is prepared by, for example, drip filtration (e.g., at 92° C.). The resulting coffee beverage is confirmed by sensory analysis (e.g., using methods as described above in Example 8) to have a more pleasant flavor profile, with decreased robusta-like coffee aromas, a milder bitterness, and more phenolic, cereal-like and chocolate-like aroma notes compared to untreated coffee (identical processing without steam treatment, infusion, and cross-Marillardization).

### Example 27

### A Cross-Maillardized Coffee Beverage is Made from Robusta and Arabica Coffees

Raw (green) robusta coffee (e.g., beans) is washed (e.g., stirred) using hot water (80° C., 1:1, wt/wt) for 1 h, the aqueous phase separated and the remaining green coffee beans dried by lyophilization [a_{w}<0.3]. Additionally, arabica coffee (e.g., beans) is soaked with hot water (80° C., 1:1, wt/wtt) for 1 h, and directly lyophilized (without first separating the aqueous phase).

Both lyophilized coffees, the washed robusta, and the soaked arabica are combined (75:25, wt/wt), and an aqueous solution, containing 2% molasses, 2% malt extract, 2.5% glycine and 2.5% mung protein hydrolysate, is added (1:2, wt/wt beans:solution). The mixture is stirred at 55° C. for 6 h, and the preconditioned coffees briefly rinsed with water, before adjusting the rinsed coffee to a a_{w}<0.75 by dehydrating at 55° C. The dehydrated preconditioned coffee blend is roasted to a final temperature of 210° C., the roasted, cross-Maillardized coffee ground, and a hot coffee beverage is prepared from the grounds by e.g., drip filtration (e.g., at 92° C.). The prepared coffee beverage is confirmed by sensory analysis (e.g., using methods as described above in Example 8) to have improved sensory qualities, compared to the robusta coffee alone, with a decreased acrylamide content and a more malt- and caramel-like aroma.

### Example 28

### A Cross-Maillardized Coffee Extract/Flavoring is Made from Coffee

Raw (green) coffee (e.g., beans or chunks, preferably of low quality) is washed (e.g., stirred) with hot water (80° C., 1:1, wt/wt) for 1 h, the aqueous phase is separated and the remaining green coffee is dried by lyophilization (e.g., a_{w}<0.3). To the freeze-dried coffee, an aqueous solution (1:2, wt/wt coffee:solution), containing 5% maltodextrins, and 5% of plant protein hydrolysates (e.g., rice protein and/or pea protein hydrolysate) is added, and the mixture stirred for 8 h at room temperature. The stirred mixture, including the supernatant, is dried at 55° C. for 16 h to adjust the coffee to a a_{w}<0.60, and the surface of the preconditioned beans briefly rinsed with water, dried again at 55° C. for 2 h (to a_{w}<0.60), and then roasted to a final temperature of 210° C. The roasted, cross-Maillardized coffee is ground and the grounds extracted multiple times with hot water (e.g., immersion brew; at e.g., 92° C.). The extracts are combined, and water is removed (e.g., under reduced pressure or by reverse osmosis). The concentrated extract can be used as a coffee-type flavoring for beverages, confirmed by sensory analysis (e.g., using methods as described above in Example 8) to have increased sensory properties compared to non-cross-Maillardized coffee.

### Example 29

### A Roast and Ground Cross-Maillardized Coffee is Made from Coffee and Sesame

Raw (green) coffee (e.g., beans or chunks, preferably of low quality) is washed (e.g., stirred) with hot water (80° C., 1:1, wt/wt) for 1 h, the aqueous phase is separated and the remaining green coffee is dried by lyophilization (e.g., a_{w}<0.3). To the freeze-dried coffee, an aqueous solution (1:2, wt/wt coffee:solution) containing 5% maltodextrins, and 5% of plant protein hydrolysates (e.g., rice protein and/or pea protein hydrolysate) is added, and the mixture stirred for 8 h at room temperature. The stirred mixture, including the supernatant, is dried at 55° C. for 16 h to adjust the coffee to a a_{w}<0.60, and the surface of the preconditioned coffee is briefly rinsed with water, dried again at 55° C. for 2 h (to a_{w}<0.60), and then roasted to a final temperature of 210° C. Additionally sesame (e.g., seeds) is prepared by roasting it to a final temperature of 220° C. in 3 minutes.

The roasted preconditioned coffee and the roasted sesame are mixed (95/5, wt/wt coffee:sesame), homogenized, applied to a grinder setup and finely ground. The ground product is immediately filled into bags having a CO₂ valve for degassing. The interiors of the bags are placed under vacuum to protect produced the formed flavor from oxidation, and the bags sealed for storage.

The roast and ground product can be brewed like conventional coffee, with the cross-Maillardized coffee in combination with sesame confirmed by sensory analysis (e.g., using methods as described above in Example 8) to have a more intense coffee-like flavour and roasted aroma, with a higher overall aroma intensity compared to identical processing without cross-Marillardization.

### Example 30

### A Cross-Maillardized Coffee Beverage is Made from Coffee and Buckwheat

Raw (green) coffee (e.g., beans or chunks, preferably of low quality) is washed (e.g., stirred) with hot water (80° C., 1:1, wt/wt) for 1 h, the aqueous phase is separated and the remaining green coffee is dried by lyophilization (a_{w}<03). The freeze-dried coffee and raw buckwheat are combined (75/25, w/w coffee:buckwheat), homogenized, and an aqueous solution (1:2, w/w coffee-buckwheat:solution) containing 5% maltodextrins, and 5% of plant protein hydrolysates (e.g., rice protein and/or pea protein hydrolysate) is added, and the mixture stirred for 8 h at room temperature. The stirred mixture, including the supernatant, is dried at 55° C. for 16 h to adjust the coffee to a a_{w}<0.60, the surface of the preconditioned coffee-buckwheat mixture briefly rinsed with water to remove residual sugars/amino acid, dried again at 55° C. for 2 h (to a_{w}<0.60), and then roasted together to a final temperature of 195° C. in a hot air roaster. The roasted, cross-Maillardized coffee-buckwheat mixture is ground and extracted multiple times with hot water (e.g., 92° C., under pressure), with the aroma being stripped and collected separately (e.g., by means of trapping the volatile aroma compounds via molecular distillation, or by simply collecting the volatiles in the headspace in a cold trap (e.g., cooled with liquid nitrogen, dry ice)). The aroma-free extract is then spray-dried, and combined/coated with the previously separately collected aroma fraction. The derived granular, powdery and dry coffee-buckwheat mixture may, e.g., be used as conventional soluble/instant coffee (3 g/200 mL), with the preconditioned, cross-Maillardized coffee-buckwheat confirmed by sensory analysis (e.g., using methods as described above in Example 8) to have a more distinct roast, caramel, nutty and chocolate-like aroma profile compared to identical processing without cross-Maillardization.

### Example 31

### A Coffee-Like Beverage is Made from Regenerated Traditional Spent (Previously Extracted) Coffee Grounds

This example describes regenerating traditional spent (previously extracted) coffee grounds to make several product types: a) regenerated/reformulated coffee grounds are prepared from spent coffee grounds; b) reformulated spent coffee grounds extract is prepared; and c) a finished reformulated spent grounds beverage is produced, as follows:

a) Dry retentate (spent) grounds from the production of a coffee beverage are formulated (e.g., mixed, combined, coated, infused, soaked, etc.) with an amount of an exogenous cross-Maillardized flavor or beverage component (e.g., a concentrated extract or lyophilized form thereof, made from coffee or from non-coffee substrate materials by the presently disclosed cross-Maillardization methods), the amount sufficient to coat and/or infuse the retentate grounds to rejuvenate the organoleptic quality potential thereof;

b) Dried reformulated spent grounds of a) are extracted (brewed) in. e.g., 92° C. water for 4 minutes before gravity filtration, or alternatively extracted in a portafilter of an espresso machine), in either case to provide a reformulated spent coffee grounds extract fraction) and a retentate extracted reformulated coffee grounds fraction (spent reformulated coffee grounds fraction), followed by cooling (e.g., to 4° C.) of the liquid reformulated coffee grounds extract fraction for storage.

c) For final formulation, the liquid reformulated coffee grounds extract fraction from b) may be combined with one or more of caffeine, colorants, gums and/or flavors, filled into cans with nitrogen (e.g., under nitrogen atmosphere and/or flushed with nitrogen to replace trapped CO₂) and retorted.

In further examples, spent grounds from non-coffee substrate materials may likewise be regenerated/rejuvenated by formulating with an amount of an exogenous cross-Maillardized flavor or beverage component.

### Example 32

### A Coffee-Like Beverage is Made from Regenerated Traditional Spent (Previously Extracted) Coffee Grounds

Previously extracted (spent) coffee grounds were treated with an exo-protease (Novozymes Flavourzyme™, 0.1%) in an aqueous solution. The enzymes were deactivated at 80° C. for 10 min, and the a_{w} adjusted by dehydrating to <0.7 at 55° C. for 16 hours, leaving the enzymatically-treated spent grounds. The dried, treated spent grounds were then combined with an aqueous solution (1:2, w/w grounds:solution) containing 1% caffeine, 2% w/w chlorogenic acid derivatives (e.g., derived from eucommia bark), 1% w/w leucine, 1% w/w lysine, 2.5% w/w pea protein hydrolysate and 5% w/w molasses. The mixture was stirred at 60° C. for 3 hours at pH 8.5, and the water removed by dehydrating at 55° C. for 16 hours to achieve a a_{w}<0.6. The dried, preconditioned spent grounds were then heated to 140° C. for 30 min in an electric oven, to provide for cross-Maillardization. The derived regenerated spent coffee grounds were then used to prepare a drip coffee beverage (23 g/320 mL) that was confirmed by sensory analysis (e.g., using methods as described above in Example 8) to have sensory characteristics similar to coffee prepared from non-spent coffee grounds.

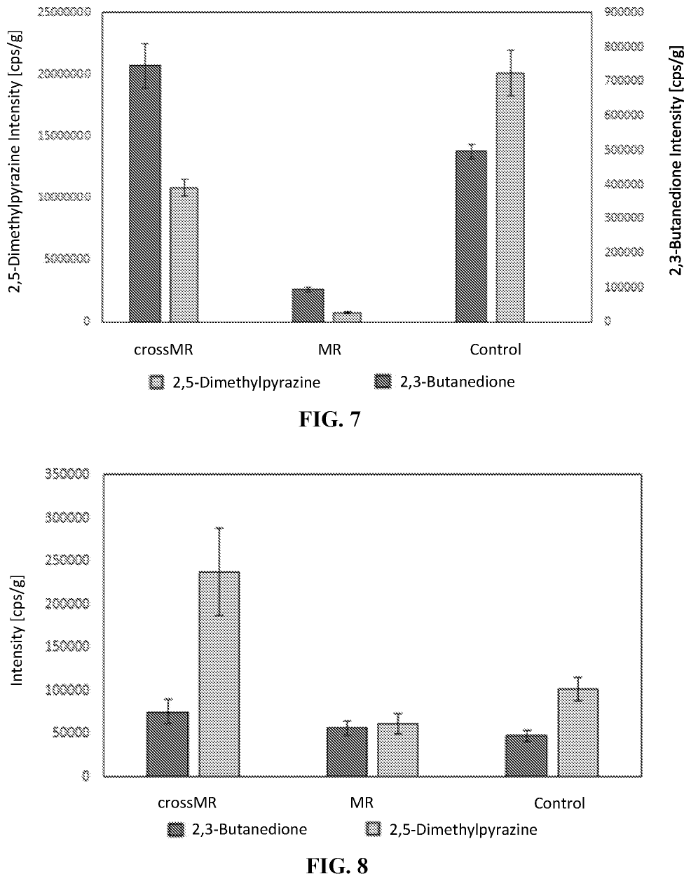

This rejuvenated composition was further analyzed by Headspace-SPME-GC/MS, using methods analogous to Example 9, and the results summarized in FIG. 8. FIG. 8 shows that in this example, while the levels of 2,3-butanedione (diacetal) are relatively unchanged, the level of 2,5-dimethylpyrazine was substantially enhanced by cross-Maillardization, in this case in the presence of optionally added chlorogenic acid, of previously roasted, ground and extracted coffee beans. According to particular aspects, use of added chlorogenic acid tends to favor Maillard reactions over carmelization (e.g., more pyrazine, whereas the 2,3-butanedione level is relatively unchanged).

Pyrazines in coffee contribute to the earthy, roasted-type aroma characteristic of the roasted product and beverages made from it. These data reveal that the disclosed compositions and cross-Maillardization methods effectively rejuvenate spent (previously roasted, ground and extracted) coffee grounds, such that key aroma compounds like 2,5-dimethylpyrazine can be created in-situ and are available for subsequent extraction using conventional coffee production techniques.

### Example 33

### Spent Coffee Grounds were Reformulated Using a Cross-Maillardization Product Made by Concentrating an Extract of Roasted, Cross-Maillardized Date Seeds

Spent (previously extracted) coffee grounds were dried to a_{w}<0.4. The dried spent grounds were reformulated by initially combining 25 g of the dried grounds with 5 g of a dry, cross-Maillardization product (made by concentrating an extract of roasted, cross-Maillardized date seeds to >99% solids using a refractance window drying system), and then adding 0.6 g of soluble fiber, 0.15 g of dry flavor, 0.1 g of dry, soluble color, 0.11 g of caffeine, and 0.1 g of roasted, ground chicory root. The resulting mixture was blended and extracted using a drip percolation system. The resulting beverage was determined by sensory analysis (e.g., as in Example 8) to resemble freshly brewed coffee in taste, appearance and texture, with prominent dark roasted notes, dark color, moderate body and the expected levels of caffeine from a fresh brew.

### Example 34

### A Ground Coffee-Like Product is Made by Rejuvenating Spent Coffee Grounds Using Liquid Cross-Maillardization-Derived Products

Spent coffee grounds are dried to a_{w}<0.6. These dried grounds are then soaked in a liquid cross-Maillardized date seed extract (e.g., as prepared in Example 1a), or in a liquid concentrate thereof, for 2 hours at room temperature, then dried to a a_{w}<0.6. The rejuvenated grounds may be further formulated by addition of dry flavoring preparations, caffeine, soluble color compounds and/or texture modifying ingredients such as gums.

The dried rejuvenated, optionally reformulated spent grounds may be extracted (brewed) to provide a reformulated spent coffee grounds extract fraction, confirmed by sensory analysis (e.g., using methods as described above in Example 8) to have a roasted coffee-like character.

### Example 35

### A Ground Coffee-Like Product is Made by Rejuvenating Spent Coffee Grounds Using Dried Cross-Maillardization-Derived Products/Materials

A dried Cross-Maillard rejuvenation material is produced by taking a liquid extract of a cross-Maillardized substrate (e.g., prepared as described herein from one or more of date seeds, chicory root, yerba mate, mustard seed, etc.), or concentrate thereof (e.g., prepared by optionally concentrating using an osmotic or low pressure process), and further dehydrating it using a process such as microwave drying, refractance window, vacuum belt drying, etc., to provide a dry powder. The dry, cross-Maillardization derived powder is then added (e.g., mixed, combined, coated, infused, soaked, etc.) to spent coffee grounds previously dried to a_{w}<0.6. These rejuvenated grounds may be further formulated by addition of one or more of: dry flavorings, caffeine, soluble colors and/or texture modifying ingredients such as gums, etc. The dried rejuvenated, optionally reformulated spent coffee grounds may be extracted (brewed) to provide a reformulated spent coffee grounds extract fraction, confirmed by sensory analysis (e.g., using methods as described above in Example 8) to have particular roasted coffee-like characters reflecting the particular cross-Maillardized rejuvenation material(s) used.

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the invention extend beyond the specifically disclosed embodiments to other alternative embodiments and/or uses and modifications and equivalents thereof.

In some embodiments, the numbers expressing quantities of ingredients, properties such as molecular weight, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

The embodiments of the application disclosed herein are illustrative of the principles of the embodiments of the invention. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A method of preparing a beverage component, comprising:
contacting a substrate carrier material, having an endogenous Maillard-reactive nitrogen constituent and/or an endogenous Maillard-reactive carbohydrate constituent, with an exogenous Maillard reagent comprising an exogenous Maillard-reactive nitrogen constituent and/or an exogenous Maillard-reactive carbohydrate constituent to provide a conditioned substrate carrier material; and
adjusting the water activity (a_{w}) of the conditioned substrate carrier material to a value less than that of the conditioning reaction, and reacting, during the adjusting and/or at the adjusted a_{w} value, the exogenous Maillard reagent with the endogenous Maillard-reactive nitrogen constituent and/or with the endogenous Maillard-reactive carbohydrate constituent to provide a low water activity (low a_{w}) cross-Maillardized substrate carrier material having cross-Maillard reaction products (LWACMP) formed by the reaction between the exogenous Maillard reagent, and the endogenous Maillard-reactive constituent(s).

2. The method of claim 1, wherein the conditioned substrate carrier material, prior to adjusting the a_{w}, comprises a cross-Maillardized substrate carrier material having cross-Maillard reaction products (HWACMP).

3. The method of claim 1 or 2, wherein the endogenous Maillard-reactive nitrogen constituent comprises one or more of amino acids, oligopeptides, polypeptides, and/or proteins, and/or wherein the endogenous Maillard-reactive carbohydrate constituent comprises one or more of mono-, di-, oligosaccharide, and/or polysaccharides.

4. The method of any one of claims 1-3, wherein the exogenous Maillard-reactive nitrogen constituent comprises one or more of amino acids, oligopeptides, polypeptides, and/or proteins, and/or wherein the exogenous Maillard-reactive carbohydrate constituent comprises one or more of mono-, di-, oligosaccharide, and/or polysaccharides.

5. The method of any one of claims 1-4, wherein the exogenous Maillard-reactive nitrogen constituent comprises one or more amino acids, and/or wherein the exogenous Maillard-reactive carbohydrate constituent comprises one or more mono- or disaccharides.

6. The method of any one of claims 1-5, wherein the substrate carrier material comprises a natural and/or a processed or restructured plant material having the endogenous Maillard-reactive nitrogen constituent and/or the endogenous Maillard-reactive carbohydrate constituent.

7. The method of claim 6, wherein the plant material comprises one or more selected from the group consisting of date seeds, chicory root, Yerba mate stems and/or leaves, dandelion, seeds from the mustard family (Brassicaceae), watermelon seeds, pumpkin seeds, Jerusalem artichokes, sesame seeds, cereal and non-cereal grains, and/or coffee.

8. The method of any one of claims 1-7, wherein contacting the substrate carrier material with the exogenous Maillard reagents comprises contacting with an aqueous solution of the exogenous Maillard reagents.

9. The method of any one of claims 1-8, wherein contacting the substrate carrier material with the exogenous Maillard reagent comprises contacting at least the surface of the substrate carrier material with the exogenous Maillard reagent, and promoting adsorption, absorption, or adherence (e.g., covalently or physically) of the exogenous Maillard reagent, and/or of reaction products thereof, to at least the surface of the conditioned carrier material.

10. The method of any one of claims 1-9, wherein contacting the substrate carrier material with the exogenous Maillard reagent comprises contacting at one or more conditioning temperature(s), under conditions and for a time period sufficient to provide for infusion of the exogenous Maillard reagent into at least the surface of the substrate carrier material, and/or solubilization and/or depolymerization of the endogenous Maillard-reactive nitrogen constituent and/or the endogenous Maillard-reactive carbohydrate constituent thereof.

11. The method of any one of claims 1-10, wherein the LWACMP comprises cross-Maillardized reaction products on at least the surface thereof.

12. The method of any one of claims 1-11, wherein adjusting the a_{w} comprises adjusting to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.1, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70.

13. The method of any one of claims 1-12, wherein adjusting the a_{w} comprises drying the conditioned substrate carrier material at one or more drying temperatures.

14. The method of any one of claims 1-13, further comprising restructuring one or more of the substrate carrier material, the conditioned substrate carrier material, and/or the LWACMP.

15. The method of any one of claims 1-14, wherein the restructuring comprises one or more of fragmenting, grinding, milling, micronizing, depolymerizing, solubilizing, permeabilizing, compacting and/or compressing the respective substrate carrier material.

16. The method of any one of claims 1-15, further comprising heating the LWACMP under conditions sufficient to promote further Maillardization thereof, to provide an elevated temperature, cross-Maillardized substrate carrier material having cross-Maillard reaction products (ET-LWACMP).

17. The method of claim 16, wherein the adjusting the water activity (a_{w}) of the conditioned substrate carrier material to provide the LWACMP, and the heating of the LWACMP to provide the ET-LWACMP are stages of one or more continuous or ramped heating process(es).

18. The method of claim 16 or 17, wherein the further Maillardization comprises further cross-Maillardization relative to the LWACMP.

19. The method of any one of claims 16-18, wherein the heating is at one or more temperatures greater than the temperature used for adjusting the water activity (a_{w}) of the conditioned substrate carrier material, or than the drying temperature.

20. The method of any one of claims 16-19, wherein the heating comprises one or more of roasting, toasting, baking, grilling, and/or otherwise thermally treating at elevated temperatures.

21. The method of any one of claims 16-20, further comprising grinding, or otherwise fragmenting, grinding, milling, micronizing, depolymerizing, solubilizing, permeabilizing, compacting, compressing and/or otherwise restructuring the ET-LWACMP.

22. The method of any one of claims 1-21, wherein the level of at least one compound present in the conditioned substrate carrier material, the LWACMP, the ET-LWACMP, or in extracts thereof is differentially modulated relative to that of the substrate carrier material or that of the exogenous reagent(s) independently subjected to the method, taken alone or in sum.

23. The method of claim 22, wherein the at least one compound comprises 2,5-dimethylpyrazine, 2,3-butanedione, 1,3-bis[(5S)-5-amino-5-carboxypentyl]-4-methyl-1H-imidazol-3-ium and/or of γ-butyrolactone.

24. The method of any one of claims 1-23, further comprising extracting the conditioned substrate carrier material, the LWACMP or the ET-LWACMP to provide an extract, and an extracted retentate substrate carrier material.

25. The method of claim 24, wherein the extracting comprises suffusing or steeping in a suitable solvent (e.g., water, ethanol, glycol, supercritical CO₂, etc.) at a suitable temperature, wherein the extract comprises an infusion, and wherein the extracted retentate substrate carrier material comprises extracted retentate restructured substrate and/or grounds.

26. The method of claim 24 or 25, further comprising addition of one or more additional ingredients to the extract to provide a blended formula.

27. The method of claim 26, wherein the one or more additional ingredients comprises one or more of dry ingredients, liquid ingredients, oil, and/or gum ingredients.

28. The method of any one of claims 24-27, comprising concentrating the extract or the blended formula, to provide a concentrated extract or concentrated blended formula.

29. The method of any one of claims 24-28, further comprising subjecting the extract or the blended formula, or the concentrates thereof, to one or more of a sterilization process (e.g. UHT, retort, microwave, ohmic), a pasteurization process (e.g. HTST), a homogenization process, or non-thermal antimicrobial treatments (e.g. HPP, irradiation) etc., optionally followed by packaging or aseptic packaging.

30. The method of any one of claims 24-29, further comprising drying of the extracted retentate substrate carrier material to provide a dried, extracted retentate substrate carrier material.

31. The method of claim 30, further comprising addition of one or more additional ingredients to the dried, extracted retentate substrate carrier material to provide a formulated retentate substrate carrier material.

32. The method of claim 31, wherein the addition of the one or more additional ingredients, comprises coating or infusing the dried, extracted retentate substrate carrier material.

33. The method of claim 31 or 32, wherein the one or more additional ingredients comprises one or more of dry ingredients, liquid ingredients, oil, gum ingredients, and/or an extract or lyophilized or dried extract of the LWACMP or of the ET-LWACMP.

34. The method of any one of claims 24-29, further comprising instantizing the extract, the blended formula, or the concentrates thereof, to provide an instantized beverage component, optionally followed by aseptic packaging.

35. The method of any one of claims 1-34, wherein the substrate carrier material comprises or is coffee or spent coffee grounds.

36. A beverage component, comprising a component prepared by the method of any one of claims 1-35.

37. The beverage component of claim 36, wherein the beverage component comprises one or more of:
a conditioned substrate carrier material having cross-Maillard reaction products (HWACMP);
a low a_{w} cross-Maillardized substrate carrier material (LWACMP) having cross-Maillard reaction products;
an elevated temperature, cross-Maillardized substrate carrier material (ET-LWACMP) having cross-Maillard reaction products formed by heating the LWACMP under conditions sufficient to promote further Maillardization thereof;
an extract of the HWACMP, the LWACMP, or the ET-LWACMP, or concentrates, blends or formulations thereof;
an extracted retentate substrate carrier material having cross-Maillard reaction products; and
a concentrated and/or instantized beverage component; and wherein any of these components are optionally packaged in single-use or multi-use pods, capsule, etc.

38. A cross-Maillardized substrate carrier material, or an extract thereof, comprising:
a low water activity (low a_{w}) cross-Maillard reaction product (LWACMP) formed, at an a_{w} value less than or equal to 0.95, between an endogenous Maillard-reactive nitrogen constituent and an exogenous Maillard-reactive carbohydrate constituent, and/or between an exogenous Maillard-reactive nitrogen constituent and an endogenous Maillard-reactive carbohydrate constituent; and/or
an elevated temperature, low water activity cross-Maillard product (ET-LWACMP).

39. The cross-Maillardized substrate carrier material, or the extract thereof, of claim 38, comprising LWACMP and ET-LWACMP.

40. The cross-Maillardized substrate carrier material, or the extract thereof, of claim 38 or 39, wherein the endogenous Maillard-reactive nitrogen constituent comprises one or more of amino acids, oligopeptides, polypeptides, and/or proteins, and/or wherein the endogenous Maillard-reactive carbohydrate constituent comprises one or more of mono-, di-, oligosaccharide, and/or polysaccharides.

41. The cross-Maillardized substrate carrier material, or the extract thereof, of any one of claims 38-40, wherein the exogenous Maillard-reactive nitrogen constituent comprises one or more of amino acids, oligopeptides, polypeptides, and/or proteins, and/or wherein the exogenous Maillard-reactive carbohydrate constituent comprises one or more of mono-, di-, oligosaccharide, and/or polysaccharides.

42. The cross-Maillardized substrate carrier material, or the extract thereof, of any one of claims 38-41, wherein the exogenous Maillard-reactive nitrogen constituent comprises one or more amino acids, and/or wherein the exogenous Maillard-reactive carbohydrate constituent comprises one or more mono- or disaccharides.

43. The cross-Maillardized substrate carrier material, or the extract thereof, of any one of claims 38-42, wherein the substrate carrier material comprises a natural and/or a processed or restructured plant material.

44. The cross-Maillardized substrate carrier material, or the extract thereof, of claim 43 wherein the plant material comprises one or more selected from the group consisting of date seeds, chicory root, Yerba mate stems and/or leaves, dandelion, seeds from the mustard family (Brassicaceae), watermelon seeds, pumpkin seeds, Jerusalem artichokes, sesame seeds, cereal and non-cereal grains and/or coffee.

45. The cross-Maillardized substrate carrier material, or the extract thereof, of claim 44 wherein the plant material comprises or is coffee or spent coffee grounds.

46. The cross-Maillardized substrate carrier material, or the extract thereof, of any one of claims 38-45, wherein the cross-Maillardized substrate carrier material comprises one or more of:
a kernel or restructured form of the cross-Maillardized substrate carrier material having LWACMP, of the cross-Maillardized substrate carrier material having ET-LWACMP, or of the cross-Maillardized substrate carrier material having LWACMP and ET-LWACMP;
an extract (e.g., aqueous) of the kernel or fragmented form of the cross-Maillardized substrate carrier material having LWACMP, of the cross-Maillardized substrate carrier material having ET-LWACMP, or of the cross-Maillardized substrate carrier material having LWACMP and ET-LWACMP;
a concentrated and/or instantized extract of the kernel or fragmented form of the cross-Maillardized substrate carrier material having LWACMP, of the cross-Maillardized substrate carrier material having ET-LWACMP, or of the cross-Maillardized substrate carrier material having LWACMP and ET-LWACMP; and
an extracted retentate cross-Maillardized substrate carrier material having LWACMP, having ET-LWACMP, or having LWACMP and ET-LWACMP; and wherein any of these components are optionally packaged in single-use or multi-use pods, capsule, etc.

47. The cross-Maillardized substrate carrier material, or the extract thereof, of any one of claims 38-46, in the form of a beverage or beverage component.

48. The cross-Maillardized substrate carrier material, or the extract thereof, of any one of claims 38-47, wherein the level of at least one compound present in the LWACMP, in the ET-LWACMP, or in extracts thereof is differentially modulated relative to that of a corresponding non-cross-Maillardized substrate carrier material.

49. The cross-Maillardized substrate carrier material, or the extract thereof, of claim, 48 wherein the at least one compound comprises 2,5-dimethylpyrazine, 2,3-butanedione, 1,3-bis[(5 S)-5-amino-5-carboxypentyl]-4-methyl-1H-imidazol-3-ium and/or of γ-butyrolactone.

50. A cross-Maillard-primed substrate carrier material, comprising a non-liquid combination of: a substrate carrier material having an endogenous Maillard-reactive nitrogen constituent and/or an endogenous Maillard-reactive carbohydrate constituent; and an exogenous Maillard reagent having an exogenous Maillard-reactive nitrogen constituent and/or an exogenous Maillard-reactive carbohydrate constituent, wherein the non-liquid combination is primed (sufficient or capable) to produce a cross-Maillardized substrate carrier material upon adjustment of water activity (a_{w}), and/or heating, and/or drying thereof; optionally packaged in single-use or multi-use pods, capsule, etc.

51. The cross-Maillard-primed substrate carrier material of claim 50, wherein:
the endogenous Maillard-reactive nitrogen constituent comprises one or more of amino acids, oligopeptides, polypeptides, and/or proteins; and/or wherein
the endogenous Maillard-reactive carbohydrate constituent comprises one or more of mono-, di-, oligosaccharide, and/or polysaccharides; and/or wherein
the exogenous Maillard-reactive nitrogen constituent comprises one or more of amino acids, oligopeptides, polypeptides, and/or proteins; and/or wherein
the exogenous Maillard-reactive carbohydrate constituent comprises one or more of mono-, di-, oligosaccharide, and/or polysaccharides.

52. The cross-Maillard-primed substrate carrier material of claim 50 or 51, wherein
adjusting the a_{w} comprises adjusting to a value greater than 0.95, or to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.10, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70; wherein
drying comprises adjusting the a_{w} to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.10, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70; and wherein
heating comprises heating at, or to, a temperature above ambient temperature.

53. The cross-Maillard-primed substrate carrier material of any one of claims 50-52, wherein the non-liquid combination comprises a powder or particle form of either the substrate carrier material, the exogenous Maillard reagent, or both.

54. The cross-Maillard-primed substrate carrier material of any one of claims 50-53, wherein the substrate carrier material and/or the exogenous Maillard reagent are in the form of a bound or unbound aggregate, a direct compression, a dry granulation, wet granulation, extrusion and in each case may optionally comprise one or more further excipients (e.g., binder, distintegrant, lubricant, etc.).

55. The cross-Maillard-primed substrate carrier material of any one of claims 50-54, wherein the substrate carrier material and the exogenous Maillard reagent are in the form of a compressed or compacted, bound or unbound, kernel, bean, pellet or other form.

56. The cross-Maillard-primed substrate carrier material of any one of claims 50-55, wherein the substrate carrier material comprises a natural and/or a processed or restructured plant material.

57. The cross-Maillard-primed substrate carrier material of claim 56, wherein the plant material comprises one or more selected from the group consisting of date seeds, chicory root, Yerba mate stems and/or leaves, dandelion, seeds from the mustard family (Brassicaceae), watermelon seeds, pumpkin seeds, Jerusalem artichokes, sesame seeds, cereal and non-cereal grains and/or coffee.

58. The cross-Maillard-primed substrate carrier material of claim 57, wherein the plant material comprises or is coffee or spent coffee grounds.

59. A method of making a cross-Maillard-primed substrate carrier material, comprising combining:
a substrate carrier material having an endogenous Maillard-reactive nitrogen constituent and/or an endogenous Maillard-reactive carbohydrate constituent; and
an exogenous Maillard reagent having an exogenous Maillard-reactive nitrogen constituent and/or and exogenous Maillard-reactive carbohydrate constituent, to provide a non-liquid combination, wherein the non-liquid combination is primed (sufficient or capable) to produce a cross-Maillardized substrate carrier material upon adjustment of water activity (a_{w}), and/or heating, and/or drying thereof.

60. The method of claim 59, wherein:
the endogenous Maillard-reactive nitrogen constituent comprises one or more of amino acids, oligopeptides, polypeptides, and/or proteins; and/or wherein
the endogenous Maillard-reactive carbohydrate constituent comprises one or more of mono-, di-, oligosaccharide, and/or polysaccharides; and/or wherein
the exogenous Maillard-reactive nitrogen constituent comprises one or more of amino acids, oligopeptides, polypeptides, and/or proteins; and/or wherein
the exogenous Maillard-reactive carbohydrate constituent comprises one or more of mono-, di-, oligosaccharide, and/or polysaccharides.

61. The method of claim 59 or 60, wherein:
adjusting the a_{w} comprises adjusting to a value greater than 0.95, or to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.10, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70; wherein
drying comprises adjusting the a_{w} to a value less than or equal to a value selected from the group consisting of 0.95, 0.90, 0.85, 0.80, 0.75, 0.70, 0.65, 0.6, 0.55, 0.5, 0.45, 0.4, 0.35, 0.3, 0.25, 0.2, 0.15 and 0.10, or less than or equal to a value in a range of 0.10 to 0.95, including adjusting to a value less than or equal to any value in any subranges therein (e.g., 0.20 to 0.85, 0.25 to 0.80, 0.25 to 0.75, 0.25 to 0.70, 0.25 to 0.65, 0.25 to 0.60, 0.25 to 0.55), preferably to a value in a range of 0.25 to 0.70; and wherein
heating comprises heating at, or to, a temperature above ambient temperature.

62. The method of any one of claims 59-61 wherein the non-liquid combination comprises a powder or particle form of either the substrate carrier material, the exogenous Maillard reagent, or both.

63. The method of any one of claims 59-62, wherein the substrate carrier material and/or the exogenous Maillard reagent are in the form of a bound or unbound aggregate, a direct compression, a dry granulation, wet granulation, or extrusion, and in each case may optionally comprise one or more further excipients (e.g., binder, disintegrant, lubricant, etc.).

64. The method of any one of claims 59-63, wherein the substrate carrier material and the exogenous Maillard reagent are in the form of a compressed or compacted, bound or unbound, kernel, bean, pellet or other form.

65. The method of any one of claims 59-64, wherein the substrate carrier material comprises or is a natural and/or a processed or restructured plant material.

66. The method of any one of claims 59-65, wherein the plant material comprises or is one or more selected from the group consisting of date seeds, chicory root, Yerba mate stems and/or leaves, dandelion, seeds from the Brassicaceae family, watermelon seeds, pumpkin seeds, Jerusalem artichokes, sesame seeds, cereal and non-cereal grains and/or coffee.

67. The method of claim 66, wherein t the plant material comprises or is coffee or spent coffee grounds.

68. A cross-Maillard-primed substrate carrier material, prepared the method of any one of claims 59-67.

69. A method for imparting flavor and/or aroma to a cross-Maillardized or non-cross-Maillardized carrier material comprising: obtaining a substrate carrier material; and applying a beverage component according to claim 36 or 37, and/or applying a cross-Maillardized substrate carrier material, or an extract thereof, according to any one of claims 38-49.

70. The method of claim 69, wherein the carrier material comprises or is a natural and/or a processed or restructured plant material.

71. The method of claim 70, wherein the plant material comprises one or more materials selected from the group consisting of date seeds, chicory root, Yerba mate stems and/or leaves, dandelion, seeds from the Brassicaceae family, watermelon seeds, pumpkin seeds, Jerusalem artichokes, sesame seeds, cereal and non-cereal grains and/or coffee.

72. The method of claim 71, wherein the plant material comprises or is coffee or spent coffee grounds.

73. A flavor and/or aroma enhanced carrier material prepared by the method of any one of claims 69-72.
